(19) United States
(12) Patent Application Publication
(10) Pub. No.: US 2025/0267538 A1
(43) Pub. Date: Aug. 21, 2025

(54) Reconfiguration Procedure in a Wireless Communication Network

(71) Applicant: Telefonaktiebolaget LM Ericsson (publ), Stockholm (SE)

(72) Inventors: Ali Parichehrehteroujeni, Linköping (SE); Luca Lunardi, Genoa (IT); Angelo Centonza, Granada (ES); Marco Belleschi, Solna (SE)

(21) Appl. No.: 18/702,956

(22) PCT Filed: Oct. 21, 2022
(86) PCT No.: PCT/SE2022/050958

§ 371 Date: Apr. 19, 2024

Related U.S. Application Data
(60) Provisional application No. 63/270,429, filed on Oct. 21, 2021.

(51) Int. Cl. H04W 36/08; H04W 36/00; H04W 36/32; H04W 76/15

(52) U.S. Cl. CPC H04W 36/08; H04W 36/0058; H04W 36/0061; H04W 36/32; H04W 76/15

(57) ABSTRACT

A candidate target network node (14T) of a reconfiguration procedure (18) transmits, to a source network node (14S) of the reconfiguration procedure (18), information (20) predicted to characterize service that the candidate target network node (14T) would provide to a wireless communication device (12) if the candidate target network node (14T) were to be a target of the reconfiguration procedure (18). The source network node (14S) may make a decision based on this information (20). For example, the source network node (14S) may make a decision about whether the candidate target network node (14T) is to be a target of the reconfiguration procedure (18) or a decision about how to configure one or more parameters governing mobility of, or traffic steering of, the wireless communication device (12).

### TECHNICAL FIELD

The present application relates generally to a wireless communication network, and relates more particularly to a reconfiguration procedure in such a network.

### BACKGROUND

FIG. 1 depicts a 5G radio access network (RAN) architecture, e.g., as described in 3^{rd} Generation Partnership (3GPP) Technical Specification (TS) 38.401 V15.4.0. The 5G RAN is also referred to as the Next Generation (NG) RAN, i.e., NG-RAN. The NG-RAN 10 consists of a set of gNBs 10A, 10B connected to the 5G Core (5GC) 12 through the NG interface. A gNB can support Frequency Division Duplexing (FDD) mode, Time Division Duplexing (TDD) mode or dual mode operation. gNBs can be interconnected through the Xn interface. A gNB may consist of a gNB Central Unit (gNB-CU) 14 and gNB Distribution Units (gNB-DUs) 16. A gNB-CU 14 and a gNB-DU 16 are connected via an F1 logical interface. One gNB-DU 16 is connected to only one gNB-CU 14. For resiliency, a gNB-DU 16 may be connected to multiple gNB-CUs 14 by appropriate implementation. NG, Xn and F1 are logical interfaces. The NG-RAN 10 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signalling transport.

A gNB may also be connected to a Long Term Evolution (LTE) LTE eNB via the X2 interface. In another architectural option, an LTE eNB connected to the Evolved Packet Core (EPC) network is connected over the X2 interface with a so called nr-gNB. The latter is a gNB not connected directly to a core network (CN) and connected via X2 to an eNB for the sole purpose of performing dual connectivity.

The architecture in FIG. 1 can be expanded by spitting the gNB-CU 14 into two entities. One gNB-CU User Plane (UP) (gNB-CU-UP), which serves the user plane and hosts the Packet Data Convergence Protocol (PDCP) protocol, and one gNB-CU Control Plane (gNB-CU-CP), which serves the control plane and hosts the PDCP and Radio Resource Control (RRC) protocol. For completeness it should be said that a gNB-DU 16 hosts the RLC/MAC/PHY protocols, where RLC stands for Radio Link Control, MAC stands for Medium Access Control, and PHY stands for Physical.

The handover (HO) preparation procedure is used to establish necessary resources in an LTE eNB or a New Radio (NR) gNB for an incoming handover of a user device from a neighboring network node. FIG. 2 illustrates a successful handover preparation event as described in 3GPP TS 36.423 V16.7.0 for LTE and 3GPP TS 38.423 V16.7.0 for NR. In this case, the source network node 20, such as a 3GPP eNB node or a 3GPP NR gNB node, initiates the procedure by sending the HANDOVER REQUEST message 24 to the target network node 22 (i.e., a 3GPP eNB node or a 3GPP NR gNB node, respectively). When the source network node 20 sends the HANDOVER REQUEST message 24, it shall start the timer TRELOCprep. In case of a successful handover preparation, the target network node 22 transmits a HANDOVER REQUEST ACKNOWLEDGE message 26 to the source network node 20, as showed in FIG. 2. Otherwise, the target network node 22 transmits a HANDOVER PREPARATION FAILURE message as described, for instance, in FIG. 8.2.1.3-1 of the 3GPP TS 36.423 V16.7.0 for the LTE standard.

The procedure uses UE-associated signaling, and as such the HANDOVER REQUEST message 24 may comprise a number of user-specific information elements (IEs) which shall be used by the target network node 22 to serve the user device in case of successful handover preparation. Examples of user specific IEs used for handover preparation include:
Subscriber Profile ID for RAT/Frequency priority IE, if available, where RAT stands for Radio Access Technology;
The Additional RRM Policy Index, where RRM stands for Radio Resource Management;
UE History Information IE: upon receiving such IE, the target network node shall collect the information defined as mandatory in the UE History Information IE and shall, if supported, collect the information defined as optional in the UE History Information IE, for as long as the UE stays in one of its cells, and store the collected information to be used for future handover preparations;
the UE History Information from the UE IE;
the Mobility Information IE;
the Expected UE Behaviour IE;
the UE Context Reference at the SeNB IE
If the Bearer Type IE
Etc.

For a complete list of user-specific information elements exchanged between network nodes during a handover preparation event, refer to the 3GPP TS 36.423 V16.7.0 and to the 3GPP TS 38.423 V16.7.0 technical specifications for 3GPP LTE and 3GPP NR systems, respectively.

Consider now mobility robustness optimization (MRO) in LTE. Seamless handovers are a key feature of 3GPP technologies. Successful handovers ensure that the UE moves around in the coverage area of different cells without causing too much interruption in the data transmission. However, there will be scenarios when the network fails to handover the UE to the ‘correct’ neighbor cell in time and in such scenarios the UE will declare a radio link failure (RLF). The RLF will cause a poor user experience as the RLF is declared by the UE only when it realizes that there is no reliable communication channel (radio link) available between itself and the network. The cause for the radio link failure could be one of the following: (1) Expiry of the radio link monitoring related timer T310; (2) Expiry of the measurement reporting associated timer T312 (not receiving the handover command from the network within this timer's duration despite sending the measurement report when T310 was running); (3) Upon reaching the maximum number of RLC retransmissions; or (4) Upon receiving random access problem indication from the MAC entity. Upon declaring the RLF, the UE performs the re-establishment procedure. Before the standardization of MRO related report handling in the network, only the UE was aware of some statistics associated to how did the radio quality look like at the time of RLF, what is the actual reason for declaring RLF, etc. For the network to identify the reason for the RLF, the network needs more information, both from the UE and also from the neighboring base stations.

As part of the MRO solution in LTE, the RLF reporting procedure was introduced in the RRC specification in Rel-9 RA8 work. The contents of the measurement report have been enhanced with more details in the subsequent releases. Some of the measurements included in the measurement report based on the latest LTE RRC 3GPP specification are:
1) Measurement quantities (RSRP, RSRQ) of the last serving cell (PCell), where RSRP stands for Reference Signal Received Power and RSRQ stands for Reference Signal Received Quality.
2) Measurement quantities of the neighbor cells in different frequencies of different RATs (EUTRA, UTRA, GERAN, CDMA2000).
3) Measurement quantity (RSSI) associated to Wireless Local Area Network (WLAN) Access Points (APs).
4) Measurement quantity (Reference Signal Strength Indicator, RSSI) associated to Bluetooth beacons.
5) Location information, if available (including location coordinates and velocity)
6) Globally unique identity of the last serving cell, if available, otherwise the Physical Cell Identity (PCI) and the carrier frequency of the last serving cell.
7) Global unique identity or PCI and carrier frequency of cell where failure occurred (e.g., handover target cell in the case of a too early HO)
8) Time elapsed since the failure occurred
9) Tracking area code of the PCell.
10) Time elapsed since the last reception of the ‘Handover command’ message.
11) Cell Radio Network Temporary Identity (C-RNTI) used in the previous serving cell.
12) Whether or not the UE was configured with a Data Radio Bearer (DRB) having Quality of Service (QOS) Class Identifier (QCI) value of 1.
13) type of connection failure (too late handover, too early HO)
14) RLF failure cause (e.g., T310 expiration, random access problems

These measurements are typically reported to the cell in which the UE performs reestablishment via UEInformationRequest and UEInformationResponse related framework.

Based on the contents of the RLF report (especially the Globally unique identity of the last serving cell), the cell in which the UE reestablishes can forward the RLF report to the last serving cell. This forwarding of the RLF report is done to aid the original serving cell with tuning of the handover related parameters, as the original serving cell was the one who had configured the parameters associated to the UE that led to the RLF.

Two different types of inter-node MRO messages have been standardized in LTE, namely: (i) Radio link failure indication; and (ii) handover report.

The radio link failure indication procedure is used to transfer information regarding RRC re-establishment attempts or received RLF reports between eNBs. This message is sent from the eNB in which the UE performs reestablishment to the eNB which was the previous serving cell of the UE. In particular, the message is sent by the eNB2 to indicate an RRC re-establishment attempt or a reception of an RLF Report from a UE that suffered a connection failure at eNB1.

Based on the RLF report from the UE and the knowledge of in which cell the UE reestablished itself, the original source cell can deduce whether the RLF was caused due to a coverage hole or due to handover associated parameter configurations. If the RLF was deemed to be due to handover associated parameter configurations, the original serving cell can further classify the handover related failure as belonging to either a too-early class, a too-late class, or a handover to wrong cell class. These handover failure classes are explained in brief below.

Consider first whether the handover failure occurred due to the ‘too-late handover’. The original serving cell can classify a handover failure to be ‘too late handover’ when the original serving cell fails to send the handover command to the UE associated to a handover towards a particular target cell and if the UE reestablishes itself in this target cell post RLF. An example corrective action from the original serving cell could be to initiate the handover procedure towards this target cell a bit earlier by decreasing the CIO (cell individual offset) towards the target cell that controls when the IE sends the event triggered measurement report that leads to taking the handover decision.

Consider next whether the handover failure occurred due to the ‘too-early handover’. The original serving cell can classify a handover failure to be ‘too early handover’ when the original serving cell is successful in sending the handover command to the UE associated to a handover however the UE fails to perform the random access towards this target cell. An example corrective action from the original serving cell could be to initiate the handover procedure towards this target cell a bit later by increasing the CIO (cell individual offset) towards the target cell that controls when the IE sends the event triggered measurement report that leads to taking the handover decision.

Consider finally whether the handover failure occurred due to the ‘handover-to-wrong-cell’ case. The original serving cell can classify a handover failure to be ‘handover-to-wrong-cell’ when the original serving cell intends to perform the handover for this UE towards a particular target cell but the UE declares the RLF and reestablishes itself in a third cell. A corrective action from the original serving cell could be to initiate the measurement reporting procedure that leads to handover towards the target cell a bit later by decreasing the CIO (cell individual offset) towards the target cell or via initiating the handover towards the cell in which the UE reestablished a bit earlier by increasing the CIO towards the reestablishment cell.

Consider now a handover report. To aid the serving cell to classify a handover as ‘too-late’ handover, the RLF reporting from the reestablishment cell to the original source cell is enough. To classify a handover as ‘too early’ or ‘handover to wrong cell’, the serving cell may further benefit from a ‘handover report’ message. This message is sent by the eNB1 to report a handover failure event or other critical mobility problem. The handover report message indicates the handover report type as being ‘HO too early’, “HO to wrong cell′, . . . ‘InterRAT ping-pong’. The handover report message also indicates the handover cause employed for handover from eNB2, as well as mobility information provided in the handover request message from eNB2.

There currently exist certain challenge(s). In a typical implementation of the NR handover procedure, like LTE, the handover is based on the measurement reports sent by the UE (e.g., measurement reports for inter and intra-frequency handovers). In fact, a target cell is traditionally selected by a serving node based on the radio measurements provided by the UEs (e.g., RSRP, RSRQ, SINR); the serving node sends a request to the target node which may confirm the handover request after admission control.

However, mobility control parameters configured by the source/serving RAN nodes and correspondingly the measurement reports provided by the UE may not give a complete picture of the target cells' quality of service a UE would experience if being handed over to the neighbouring RAN nodes. Indeed, it might be possible that neighbouring RAN nodes serving other potential mobility target cells may be able to provide a better service quality for a UE due to various factors effective in the experienced quality of service, such as neighbouring nodes load balancing policy, energy efficiency policy, configured slices and load per slice, as well as variation of the UEs' traffic or RAN implementation characteristics. This leads to a situation that a serving RAN node may miss to select as handover target for the UE other neighbour cells that provide a better quality of service for the UEs, as the mobility control parameters configured for the mobility procedures do not effectively allow the RAN node to realize and exploit such existing opportunities. On the other side, in some cases, although the mobility control parameters may trigger handover toward a cell belonging to the neighbouring RAN node, the neighbouring RAN node may not be able to provide the expected service rate to the handed over UEs.

### SUMMARY

Embodiments herein include a method performed by a network node configured to operate as a source network node of a reconfiguration procedure. The method comprises receiving, from a candidate target network node of the reconfiguration procedure, information predicted to characterize service that the candidate target network node would provide to a wireless communication device if the candidate target network node were to be a target of the reconfiguration procedure.

In some embodiments, the method further comprises making a decision based on the received information, e.g., a mobility or traffic steering decision. In some embodiments, the decision is a decision about whether the candidate target network node is to be a target of the reconfiguration procedure. In other embodiments, the decision is a decision about which of one or more candidate target network nodes is to be a target of the reconfiguration procedure. In yet other embodiments, the decision is a decision about whether the wireless communication device is to perform the reconfiguration procedure. In still yet other embodiments, the decision is a decision about how to configure one or more parameters governing mobility of, or traffic steering of, the wireless communication device. In some embodiments, the information is predicted to characterize a performance of service that the candidate target network node would provide to a wireless communication device if the candidate target network node were to be a target of the reconfiguration procedure. In some embodiments, the information is predicted to characterize the performance in terms of one or more of throughput, delay, jitter, packet error rate, block error rate, or traffic pattern. In some embodiments, the information is predicted to characterize the performance at an application layer.

In some embodiments, the information is predicted to characterize a duration of time for which the candidate target network node would provide service to a wireless communication device if the candidate target network node were to be a target of the reconfiguration procedure.

In some embodiments, the information is predicted to characterize radio configuration that the candidate target network node would use to provide service to a wireless communication device if the candidate target network node were to be a target of the reconfiguration procedure. In other embodiments, information is predicted to alternatively or additionally characterize radio resources used by service that the candidate target network node would provide to a wireless communication device if the candidate target network node were to be a target of the reconfiguration procedure.

In some embodiments, the information comprises, for each of one or more serving cells of the candidate target network node, information predicted to characterize service that the serving cell of the candidate target network node would provide to a wireless communication device if the serving cell of the candidate target network node were to be a target of the reconfiguration procedure. In other embodiments, the information comprises, for each of one or more candidate device configurations, information predicted to characterize service that the candidate target network node would provide to a wireless communication device configured with that candidate device configuration if the candidate target network node were to be a target of the reconfiguration procedure. In yet other embodiments, the information comprises, for each of one or more service types, information predicted to characterize the service that the candidate target network node would provide to a wireless communication device if the candidate target network node were to be a target of the reconfiguration procedure.

In some embodiments, the method further comprises transmitting, to the candidate target network node, a request for the information. In some embodiments, the information is received in response to the request.

In some embodiments, the request indicates one or more capabilities of the wireless communication device. In other embodiments, the request alternatively or additionally indicates results of one or more radio measurements of the wireless communication device. In yet other embodiments, the request alternatively or additionally indicates a trajectory of the wireless communication device. In still yet other embodiments, the request alternatively or additionally indicates one or more cells for which the information is requested. In still yet other embodiments, the request alternatively or additionally indicates one or more service types for which the information is requested. In still yet other embodiments, the request alternatively or additionally indicates one or more candidate device configurations for which the information is requested.

In some embodiments, the reconfiguration procedure is a mobility procedure, a multi-connectivity procedure, a PSCell addition or change procedure, or a conditional reconfiguration procedure.

In some embodiments, the method further comprises relaying a measurement configuration from the candidate target network node to the wireless communication device, and relaying results of measurements performed by the wireless communication device according to the measurement configuration from the wireless communication device to the candidate target network node. In some embodiments, the information is received after relaying the results to the candidate target network node.

Other embodiments herein include transmitting, to a source network node of the reconfiguration procedure, information predicted to characterize service that the candidate target network node would provide to a wireless communication device if the candidate target network node were to be a target of the reconfiguration procedure. In some embodiments, the information is predicted to characterize a performance of service that the candidate target network node would provide to a wireless communication device if the candidate target network node were to be a target of the reconfiguration procedure. In some embodiments, the information is predicted to characterize the performance in terms of one or more of throughput, delay, jitter, packet error rate, block error rate, or traffic pattern. In some embodiments, the information is predicted to characterize the performance at an application layer.

In some embodiments, the information is predicted to characterize a duration of time for which the candidate target network node would provide service to a wireless communication device if the candidate target network node were to be a target of the reconfiguration procedure.

In some embodiments, the information is predicted to characterize radio configuration that the candidate target network node would use to provide service to a wireless communication device if the candidate target network node were to be a target of the reconfiguration procedure. In other embodiments, the information is alternatively or additionally predicted to characterize radio resources used by service that the candidate target network node would provide to a wireless communication device if the candidate target network node were to be a target of the reconfiguration procedure.

In some embodiments, the information comprises, for each of one or more serving cells of the candidate target network node, information predicted to characterize service that the serving cell of the candidate target network node would provide to a wireless communication device if the serving cell of the candidate target network node were to be a target of the reconfiguration procedure. In other embodiments, the information comprises, for each of one or more candidate device configurations, information predicted to characterize service that the candidate target network node would provide to a wireless communication device configured with that candidate device configuration if the candidate target network node were to be a target of the reconfiguration procedure. In yet other embodiments, the information comprises, for each of one or more service types, information predicted to characterize the service that the candidate target network node would provide to a wireless communication device if the candidate target network node were to be a target of the reconfiguration procedure.

In some embodiments, the method further comprises receiving, from the source network node, a request for the information. In some embodiments, the information is transmitted in response to the request. In some embodiments, the request indicates one or more capabilities of the wireless communication device. In other embodiments, the request alternatively or additionally indicates results of one or more radio measurements of the wireless communication device. In yet other embodiments, the request alternatively or additionally indicates a trajectory of the wireless communication device. In still yet other embodiments, the request alternatively or additionally indicates one or more cells for which the information is requested. In still yet other embodiments, the request alternatively or additionally indicates one or more service types for which the information is requested. In still yet other embodiments, the request alternatively or additionally indicates one or more candidate device configurations for which the information is requested.

In some embodiments, the reconfiguration procedure is a mobility procedure, a multi-connectivity procedure, a PSCell addition or change procedure, or a conditional reconfiguration procedure.

In some embodiments, the method further comprises predicting the information as characterizing service that the candidate target network node would provide to a wireless communication device if the candidate target network node were to be a target of the reconfiguration procedure, and wherein the information transmitted is the predicted information. In some embodiments, the method further comprises training a machine learning model to predict the information, and predicting the information using the machine learning model. In some embodiments, the method further comprises adapting the machine learning model based on observed characteristics of service that the candidate target network node actually provides to a wireless communication device after the candidate target network node is a target of the reconfiguration procedure.

In some embodiments, the method further comprises transmitting, to the source network node, a measurement configuration that configures the wireless communication device to perform measurements on one or more signals transmitted by the candidate target network, and receiving, from the source network node, results of measurements performed by the wireless communication device according to the measurement configuration. In some embodiments, the information is predicted based on the received results.

Other embodiments herein include a network node configured to operate as a source network node of a reconfiguration procedure. The network node is configured to receive, from a candidate target network node of the reconfiguration procedure, information predicted to characterize service that the candidate target network node would provide to a wireless communication device if the candidate target network node were to be a target of the reconfiguration procedure.

In some embodiments, the network node is configured to perform the steps described above for a network node configured to operate as a source network node of a reconfiguration procedure.

Other embodiments herein include a network node configured to operate as a candidate target network node of a reconfiguration procedure. The network node is configured to transmit, to a source network node of the reconfiguration procedure, information predicted to characterize service that the candidate target network node would provide to a wireless communication device if the candidate target network node were to be a target of the reconfiguration procedure.

In some embodiments, the network node is configured to perform the steps described above for a network node configured to operate as a candidate target network node of a reconfiguration procedure.

In some embodiments, a computer program comprising instructions which, when executed by at least one processor of a network node, causes the network node to perform the steps described above for a network node. In some embodiments, a carrier containing the computer program is one of an electronic signal, optical signal, radio signal, or computer readable storage medium.

Other embodiments herein include a network node configured to operate as a source network node of a reconfiguration procedure. The network node comprises communication circuitry and processing circuitry. The processing circuitry is configured to receive, from a candidate target network node of the reconfiguration procedure, via the communication circuitry, information predicted to characterize service that the candidate target network node would provide to a wireless communication device if the candidate target network node were to be a target of the reconfiguration procedure.

In some embodiments, the processing circuitry is configured to perform the steps described above for a network node configured to operate as a source network node of a reconfiguration procedure.

Other embodiments herein include a network node configured to operate as a candidate target network node of a reconfiguration procedure. The network node comprises communication circuitry and processing circuitry.

The processing circuitry is configured to transmit, to a source network node of the reconfiguration procedure, via the communication circuitry, information predicted to characterize service that the candidate target network node would provide to a wireless communication device if the candidate target network node were to be a target of the reconfiguration procedure.

In some embodiments, the processing circuitry is configured to perform the steps described above for a network node configured to operate as a candidate target network node of a reconfiguration procedure.

Other embodiments herein include a method performed by a wireless communication device. The method comprises receiving, from a source network node of a reconfiguration procedure, a measurement configuration that configures the wireless communication device to perform measurements on one or more signals transmitted by a candidate target network node of the reconfiguration procedure. In this case, the method further comprises performing measurements according to the received measurement configuration. In this case, the method further comprises reporting results of the performed measurements to the source network node.

In some embodiments, the reconfiguration procedure is a mobility procedure, a multi-connectivity procedure, a PSCell addition or change procedure, or a conditional reconfiguration procedure.

Other embodiments herein include a wireless communication device. The wireless communication device is configured to receive, from a source network node of a reconfiguration procedure, a measurement configuration that configures the wireless communication device to perform measurements on one or more signals transmitted by a candidate target network node of the reconfiguration procedure. The wireless communication device is also configured to perform measurements according to the received measurement configuration. The wireless communication device is also configured to report results of the performed measurements to the source network node.

In some embodiments, the reconfiguration procedure is a mobility procedure, a multi-connectivity procedure, a PSCell addition or change procedure, or a conditional reconfiguration procedure.

In some embodiments, a computer program comprising instructions which, when executed by at least one processor of a wireless communication device, causes the wireless communication device to perform the steps described above for a wireless communication device. In some embodiments, a carrier containing the computer program is one of an electronic signal, optical signal, radio signal, or computer readable storage medium.

Other embodiments herein include a wireless communication device. The wireless communication device comprises communication circuitry and processing circuitry. The processing circuitry is configured to receive, from a source network node of a reconfiguration procedure, via the communication circuitry, a measurement configuration that configures the wireless communication device to perform measurements on one or more signals transmitted by a candidate target network node of the reconfiguration procedure. In this case, the processing circuitry is also configured to perform measurements according to the received measurement configuration. In this case, the processing circuitry is also configured to report results of the performed measurements to the source network node.

In some embodiments, the reconfiguration procedure is a mobility procedure, a multi-connectivity procedure, a PSCell addition or change procedure, or a conditional reconfiguration procedure.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a 5G radio access network (RAN) architecture.

FIG. 2 is a call flow diagram of a successful handover preparation event.

FIG. 3 is a block diagram of a wireless communication network according to some embodiments.

FIG. 4 is a call flow diagram for a mobility procedure according to some embodiments.

FIG. 5 is a logic flow diagram of a method performed by a first RAN node according to some embodiments.

FIG. 6 is a logic flow diagram of a method performed by a second RAN node according to some embodiments.

FIG. 7 is a logic flow diagram of a method performed by a UE according to some embodiments.

FIG. 8 is a call flow diagram for a mobility procedure according to other embodiments.

FIG. 9 is a logic flow diagram of a method performed by a first RAN node according to other embodiments.

FIG. 10 is a logic flow diagram of a method performed by a second RAN node according to other embodiments.

FIG. 11 is a logic flow diagram of a method performed by a UE according to other embodiments.

FIG. 12 is a call flow diagram for dual connectivity according to other embodiments.

FIG. 13 is a call flow diagram for mobility optimization according to other embodiments.

FIG. 14 is a chart of machine learning features according to some embodiments.

FIG. 15 is a logic flow diagram of a method performed by a source network node according to some embodiments.

FIG. 16 is a logic flow diagram of a method performed by a candidate target network node according to some embodiments.

FIG. 17 is a logic flow diagram of a method performed by a wireless communication device according to some embodiments.

FIG. 18 is a block diagram of a wireless communication device according to some embodiments.

FIG. 19 is a block diagram of a network node according to some embodiments.

FIG. 20 is a block diagram of a communication system in accordance with some embodiments.

FIG. 21 is a block diagram of a user equipment according to some embodiments.

FIG. 22 is a block diagram of a network node according to some embodiments.

FIG. 23 is a block diagram of a host according to some embodiments.

FIG. 24 is a block diagram of a virtualization environment according to some embodiments.

FIG. 25 is a block diagram of a host communicating via a network node with a UE over a partially wireless connection in accordance with some embodiments.

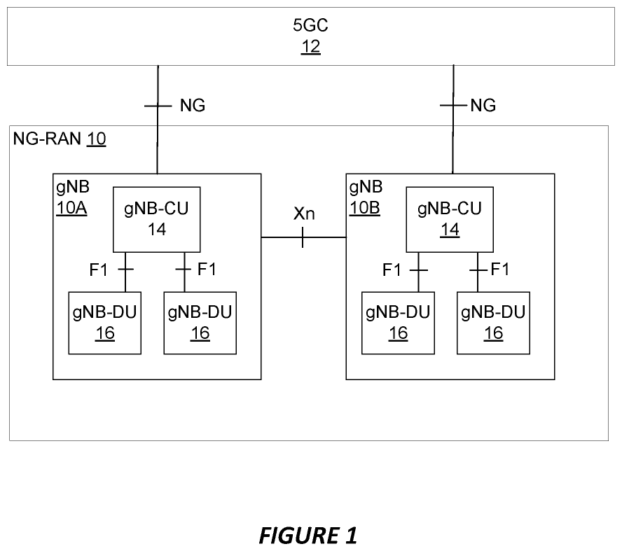

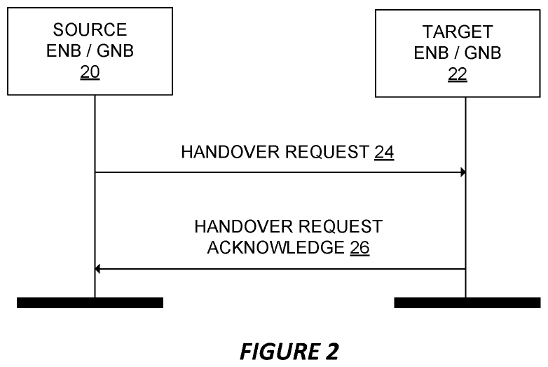

### DETAILED DESCRIPTION

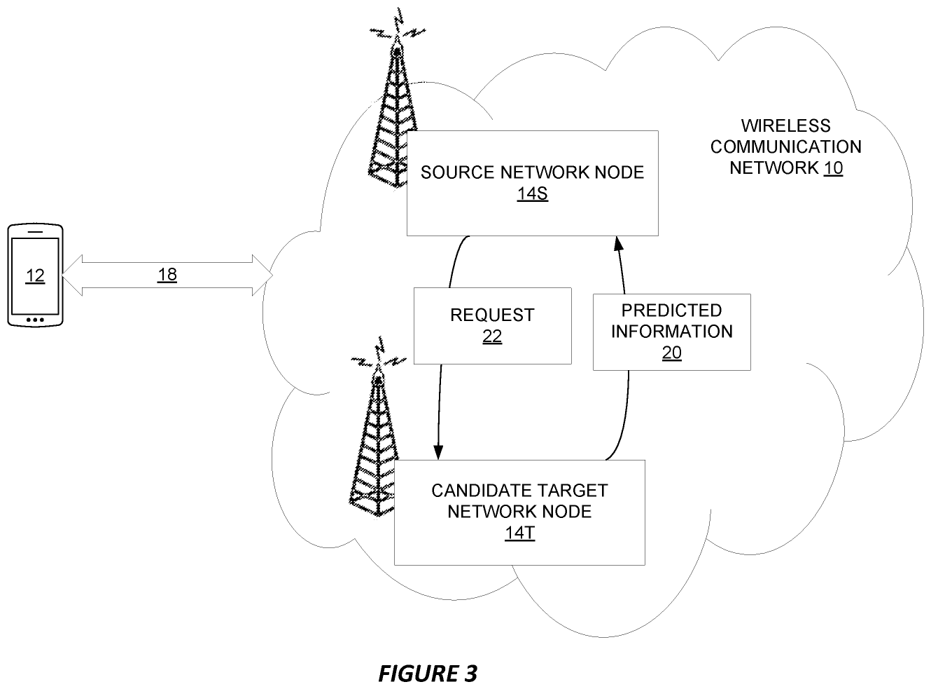

FIG. 3 shows a wireless communication network 10 according to some embodiments, e.g., a 5G or New Radio (NR) network. The wireless communication network 10 provides wireless communication service to a wireless communication device 12, e.g., a user equipment (UE).

A reconfiguration procedure 18 as shown is a procedure for reconfiguring how the wireless communication device 12 is served by the wireless communication network 10. The reconfiguration procedure 18 in this context impacts which network node(s) serve the wireless communication device 12. In one example, the reconfiguration procedure 18 is a mobility procedure (e.g., a handover procedure or a cell selection procedure) in which case the wireless communication device 12 “moves” from being served by a source network node to being served by a target network node. In another example, the reconfiguration procedure 18 is a multi-connectivity procedure, which may for instance be a PSCell addition or change procedure that adds or changes which cell(s) belong to the secondary cell group (SCG) for multi-connectivity operation. In still another example, the reconfiguration procedure 18 may be a conditional reconfiguration procedure, such as a conditional mobility procedure for mobility of the wireless communication device upon occurrence of a condition.

No matter the particular type of reconfiguration procedure 18, though, there is a source network node of the reconfiguration procedure 18 and a target network node of the reconfiguration procedure 18. The source network node is the network node that configures or triggers the reconfiguration procedure 18, and/or a network node that is serving the wireless communication device 12 before the reconfiguration procedure 18. The target network node is the network node that is the target of the reconfiguration procedure 18, in the sense that the target network node (or a cell provided by the target network node) is targeted to serve the wireless communication device 12 as a result of the reconfiguration procedure 18. The target network node may for instance be the target of a handover procedure, the target of a cell selection procedure, or the target of a PSCell addition or change procedure.

In this context, some embodiments herein assist the source network node in its decision about which network node is to be the target of the reconfiguration procedure 18. The source network node in this regard may select the target network node of the reconfiguration procedure 18 from amongst multiple candidate target network nodes that are candidates for being the target of the reconfiguration procedure 18. Notably, some embodiments herein equip the source network node with information predicted to characterize service that each candidate target network node would provide to the wireless communication device if that candidate target network node were to be the target of the reconfiguration procedure 18. This way, the source network node can more intelligently select between the candidate target network nodes taking into account the candidates' predicted services characteristics, rather than based only on signal measurements reported by the wireless communication device 12. This may in turn correspondingly enhance the performance of the reconfiguration procedure 18, the performance of the wireless communication device 12, and/or the resource efficiency of the network nodes in the wireless communication network 10.

More particularly, FIG. 3 shows a source network node 14S and a candidate target network node 14T of the reconfiguration procedure 18. The candidate target network node 14T predicts information 20 (e.g., one or more metrics) as characterizing service that the candidate target network node 14T would provide to the wireless communication device 12 if the candidate target network node 14T were to be a target of the reconfiguration procedure 18.

For example, in some embodiments, the information 20 is predicted to characterize a performance of service (e.g., at an application layer or at a physical layer) that the candidate target network node 14T would provide to the wireless communication device 12 if the candidate target network node 14T were to be a target of the reconfiguration procedure 18. The information 20 may characterize the performance at an application layer or at a physical layer, and/or in terms of one or more radio signal measurements. In these and other embodiments, the information 20 may characterize the performance in terms of one or more of: throughput; delay; jitter; packet error rate; block error rate; or traffic pattern. Alternatively or additionally, the information 20 may indicate whether the performance of service is predicted to be above or below a specified threshold.

In other embodiments, the information 20 is predicted to characterize a duration of time for which the candidate target network node 14T would provide service to the wireless communication device if the candidate target network node 14T were to be a target of the reconfiguration procedure 18. The information 20 may for example characterize the duration of time in terms of a device dwelling time in the candidate target network node 14T.

In yet other embodiments, the information 20 is predicted to characterize energy consumption attributable to service that the candidate target network node 14T would provide to the wireless communication device 12 if the candidate target network node 14T were to be a target of the reconfiguration procedure 18, e.g., where the information 18 may characterize the energy consumption in terms of energy consumed by the candidate target network node 14T and/or energy consumed by the wireless communication device 12.

In still other embodiments, the information 20 is predicted to characterize a radio configuration that the candidate target network node 14T would use to provide service to the wireless communication device 12 if the candidate target network node 14T were to be a target of the reconfiguration procedure 18. The information may for instance characterize the radio configuration in terms of a multi-connectivity configuration or a carrier aggregation configuration.

In other embodiments, the information 20 is predicted to characterize radio resources used by service that the candidate target network node 14T would provide to the wireless communication device 12 if the candidate target network node 14T were to be a target of the reconfiguration procedure 18. For example, the information 20 may be predicted to characterize the radio resources used in terms of physical resource blocks, PRBs, used.

Note, though, that the information 20 may characterize service per serving cell, per candidate device configuration, and/or per service type. For example, the information 20 may comprise, for each of one or more serving cells of the candidate target network node 14T, information 20 predicted to characterize service that the serving cell of the candidate target network node 14T would provide to the wireless communication device 12 if the serving cell of the candidate target network node 14T were to be a target of the reconfiguration procedure 18. Alternatively or additionally, the information 20 may comprise, for each of one or more candidate device configurations, information 20 predicted to characterize service that the candidate target network node 14T would provide to the wireless communication device 12 configured with that candidate device configuration if the candidate target network node 14T were to be a target of the reconfiguration procedure 18. Alternatively or additionally, the information 20 may comprise, for each of one or more types of services, information 20 predicted to characterize service of that type that the candidate target network node 14T would provide to the wireless communication device 12 if the candidate target network node 14T were to be a target of the reconfiguration procedure 18.

No matter the particular nature of the information 20, in some embodiments, the candidate target network node 14T predicts the information 20 using a model (e.g., a machine learning model) trained to predict the information 20. The candidate target network node 14T in this case may train the model and/or may adapt the model based on observed characteristics of service that the candidate target network node 14T actually provides to a wireless communication device after the candidate target network node 14T is a target of the reconfiguration procedure 18.

Regardless, FIG. 3 shows that the source network node 14S receives the information 20 from the candidate target network node 14T, e.g., before execution of the reconfiguration procedure 18. The source network node 14S may for example receive this information 20 in response to a request 22 that the source network node 14S transmits to the candidate target network node 14T for the information 20.

In some embodiments, the source network node 14S makes a decision based on the received information 20. The decision may for example be a decision about whether the candidate target network node 14T is to be a target of the reconfiguration procedure 18 and/or a decision about which of one or more candidate target network nodes is to be a target of the reconfiguration procedure 14T. Or, the decision may be a decision about whether the wireless communication device 12 is to perform the reconfiguration procedure 18. Or, as yet another example, the decision may be a decision about how to configure one or more parameters governing mobility of, or traffic steering of, the wireless communication device 12.

Alternatively or additionally, the source network node 14S may initiate the reconfiguration procedure 18 based on the received information 20.

Consider now examples of some embodiments herein in a context where the wireless communication device 12 is exemplified as a user equipment (UE), the source network node 14S is exemplified as a source radio access network (RAN) node, and the candidate target network node 14T is exemplified as a candidate target RAN node.

One such example provides solutions to challenges with mobility control. Current handover mechanisms are oblivious to the performance a potential mobility target cell may deliver for a given user equipment (UE). Some embodiments herein in this regard enable a mechanism for a RAN node to request an estimated/predicted performance for the UE if being served by one or more cells served by one or more neighbouring RAN nodes. The RAN node can use the estimated/predicted performance in mobility functions such as the handover (HO) function, conditional handover (CHO) function, and dual connectivity such as Secondary Cell Group (SCG) addition or SCG change.

Alternatively or additionally, the source RAN node can specify to the target RAN node in which coverage region of the one or more target cells served by the target RAN node the UE would be located.

In another embodiment, the source RAN triggers a request towards the target RAN serving one or more of the potential mobility target cells, to receive indications (e.g., metrics, performance measurements) of how a UE with specific characteristics would be served by the target cell if the UE is in a given coverage region of the target cell.

The UE characteristics the source RAN may specify to the target RAN may include one or more of the following: (i) key UE capabilities, such as supported band combinations and supported feature sets; (ii) services in use by the UE, including its quality of service (QOS) parameters, serving public land mobile network (PLMN), network slice per service, etc. (iii) UE measurements as taken by the UE while in the source cell; (iv) UE mobility history, e.g., the identity of cells the UE moved across in the past, the dwelling time for the UE in each cell, etc. (v) UE mobility status, such as the UE speed, the UE position at the time of sending the request, etc.

In return to both methods described above, the target RAN in some embodiments signals to the source RAN, on a per potential target cell basis, an estimation of how the UE will be served in the target cell. Such estimation may include: (i) Expected throughput, delay, jitter, and/or packet losses, on a cumulative basis, per service basis, per DRB (Data Radio Bearer) basis, per protocol data unit (PDU) Session basis, per slice basis, per QoS class basis (e.g., per 5QI), and/or per serving PLMN basis; (ii) expected energy consumption for the RAN, for example as a delta change with respect to the energy consumption at the RAN before mobility; (iii) expected energy consumption for the UE once at the target cell; (iv) possible configuration used by the target RAN for the UE, for example whether the UE will be configured with dual connectivity (DC) or with carrier aggregation (CA).

With the performance estimation received by the source RAN from the target RAN, the source RAN is able to take an optimal choice of which target cell is the best, taking into account radio conditions for the UE subject to mobility, as well as the potential performance with which the UE will be served once connected to the target cell.

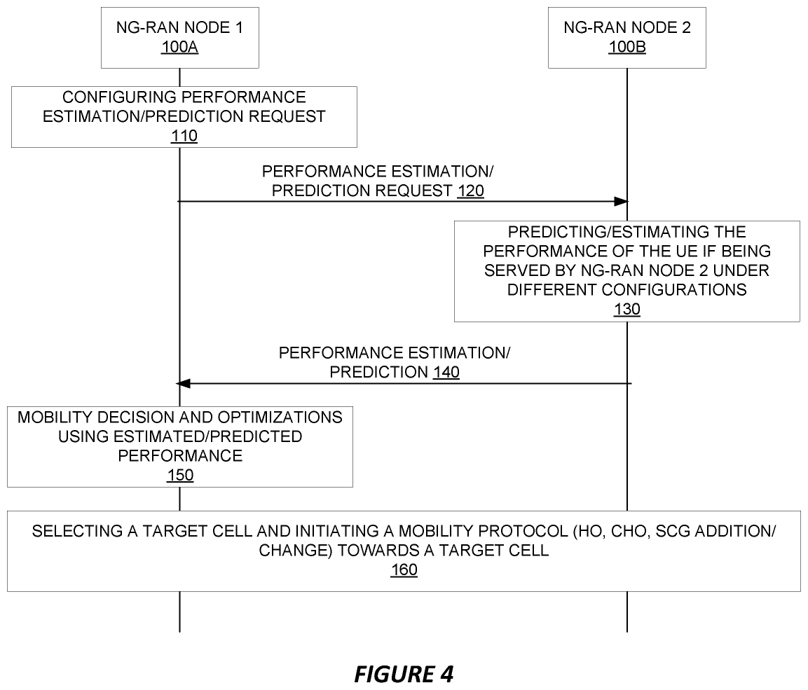

FIG. 4 shows an example of the two embodiments described above, where NG-RAN node 1 (100A) exemplifies the source network node 14S and NG-RAN node 2 (100B) exemplifies a candidate target network node 14T. As shown, NG-RAN node 1 (100A) configures a performance estimation/prediction request (Step 110), e.g., as an example of the request 22 in FIG. 3. NG-RAN node 1 (100A) sends this performance estimation/prediction request to the NG-RAN node 2 (100B) (Step 120).

Responsive to this request, NG-RAN node 2 (100B) predicts/estimates the performance of the UE if being served by NG-RAN node 2 (100B) under different configurations (Step 130). NG-RAN node 2 (100B) then sends this performance estimation/prediction to NG-RAN node 1 (100A) (Step 140).

NG-RAN node 1 (100A) performs a mobility decision and optimizations using the estimated/predicted performance (Step 150). That is, NG-RAN node 1 (100A) performs mobility optimization upon receiving a performance estimation by the neighbouring RAN node(s). Accordingly, NG-RAN node 1 (100A) as shown may select a target cell and initiate a mobility protocol (e.g., HO, CHO, SCG addition or change) towards the selected target cell.

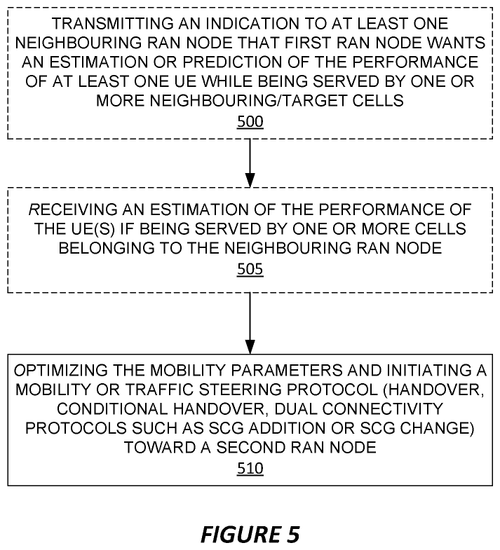

Generally, then, some embodiments herein include a method, performed by a first RAN node, as shown in FIG. 5. The first RAN node is an example of source network node 14S in FIG. 3. The method comprises transmitting an indication to at least one neighbouring RAN node that first RAN node wants an estimation or prediction of the performance of at least one UE while being served by one or more neighbouring/target cells (Block 500).

In some embodiments, the indication is an example of the request 22 in FIG. 3. Alternatively or additionally, the at least one neighbouring RAN node in some embodiments includes a second RAN node, e.g., the candidate target network node 14T in FIG. 3.

In some embodiments, the indication includes the UE(s) capabilities, services in use by the UE, UE mobility history, the UE(s) radio measurements, and/or other traffic/trajectory information.

In an embodiment, the UE(s) is (are) still served by the first RAN node, when the performance estimation request is sent to the neighbouring RAN node.

In any event, the method in some embodiments further includes receiving an estimation of the performance of the UE(s) if being served by one or more cells belonging to the neighbouring RAN node (Block 505). In some embodiments, the received estimation of the performance is an example of the predicted information 20 in FIG. 3.

The method in some embodiments further comprises optimizing the mobility parameters and initiating a mobility or traffic steering protocol (handover, conditional handover, dual connectivity protocols such as SCG addition or SCG change) toward a second RAN node (Block 510).

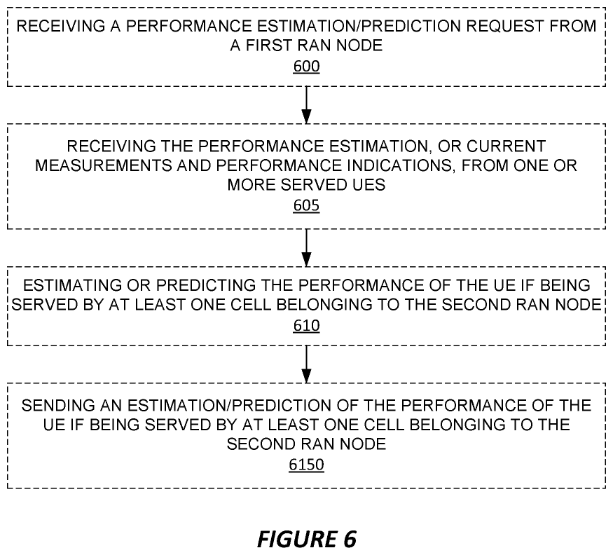

Some embodiments herein include a corresponding method performed by a second RAN node, as shown in FIG. 6. The second RAN node is an example of a candidate target network node 14T in FIG. 3.

The method comprises receiving a performance estimation/prediction request from a first RAN node, e.g., source network node 14S in FIG. 3 (Block 600). In some embodiments, this request is an example of the request 22 in FIG. 3.

In some embodiments, the method further comprises receiving the performance estimation, or current measurements and performance indications, from one or more served UEs (Block 605).

In some embodiments, the method also comprises estimating or predicting the performance of the UE if being served by at least one cell belonging to the second RAN node (Block 610). In one embodiment, the performance estimation/prediction can be done based on different configurations in different cells. In some embodiments, the performance estimation/prediction can include: expected QoS with which the UE will be served, expected energy consumption for the RAN when serving the UE, expected energy consumption for the UE when served by the target cell, or possible configuration used by the target RAN for the UE.

In some embodiments, the method further comprises sending an estimation/prediction of the performance of the UE if being served by at least one cell belonging to the second RAN node (Block 615). The performance estimation/prediction can be listed based on different configuration in different cells. In some embodiments, the performance estimation/prediction is an example of the predicted information 20 in FIG. 3.

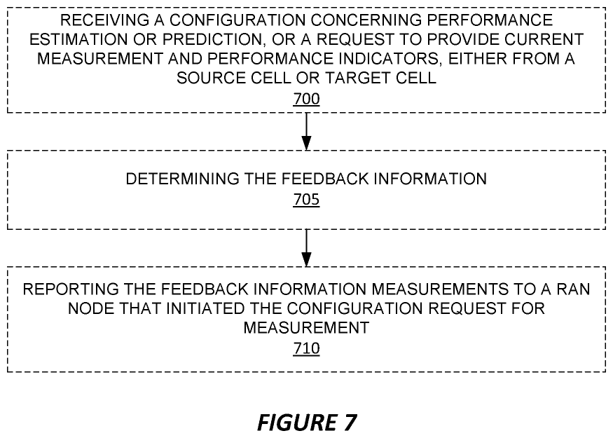

Some embodiments herein also include a method performed by a wireless terminal (also called User Equipment-UE), as shown in FIG. 7. The method comprises receiving a configuration concerning performance estimation or prediction, or a request to provide current measurement and performance indicators, either from a source cell or target cell (Block 700).

In some embodiments, the method comprises determining the feedback information, e.g., by performing measurements, by including available information in a report, by logging available information in a UE variable, etc. (Block 705).

In some embodiments, the method then comprises reporting the feedback information measurements to a RAN node that initiated the configuration request for measurement (Block 710). The RAN node to which the feedback information measurements are reported may be either the source or neighbouring RAN node.

Some embodiments herein thereby allow a serving RAN node to request performance estimation/prediction performed by neighbouring RAN nodes, e.g., potential target cells for handover or reconfiguration with sync procedures or dual connectivity operations such as SCG addition or SCG change. Some embodiments effectively enable the serving RAN node to find an optimal target RAN node for mobility or traffic steering purposes based on the provided estimation/prediction of the UEs if being served by the neighbouring RAN nodes.

In other words, upon request by a serving RAN node, the neighbouring RAN nodes provide an estimation or prediction of how a UE potentially served by another RAN node may be served if moved to a specific neighbour cell. Hence, the serving RAN node can incorporate this estimation or prediction in the mobility and traffic steering decisions and is able to perform an optimal selection to the mobility target cell.

Certain embodiments may provide one or more of the following technical advantage(s). Some embodiments enhance the performance of the mobility procedures such as handover procedure, reconfiguration with sync, and/or dual connectivity operations such as SCG addition and SCG change. In some embodiments, the serving RAN node not only uses the UE reported measurements to decide about initiating a mobility procedure, but also it incorporates an estimation/prediction of the UE performance if the UE is being served by a cell belonging to a neighbouring RAN node. This provides an opportunity for the serving RAN node to opportunistically use the available services by the neighbouring RAN nodes—the available services that would heretofore not be revealed to the serving RAN node.

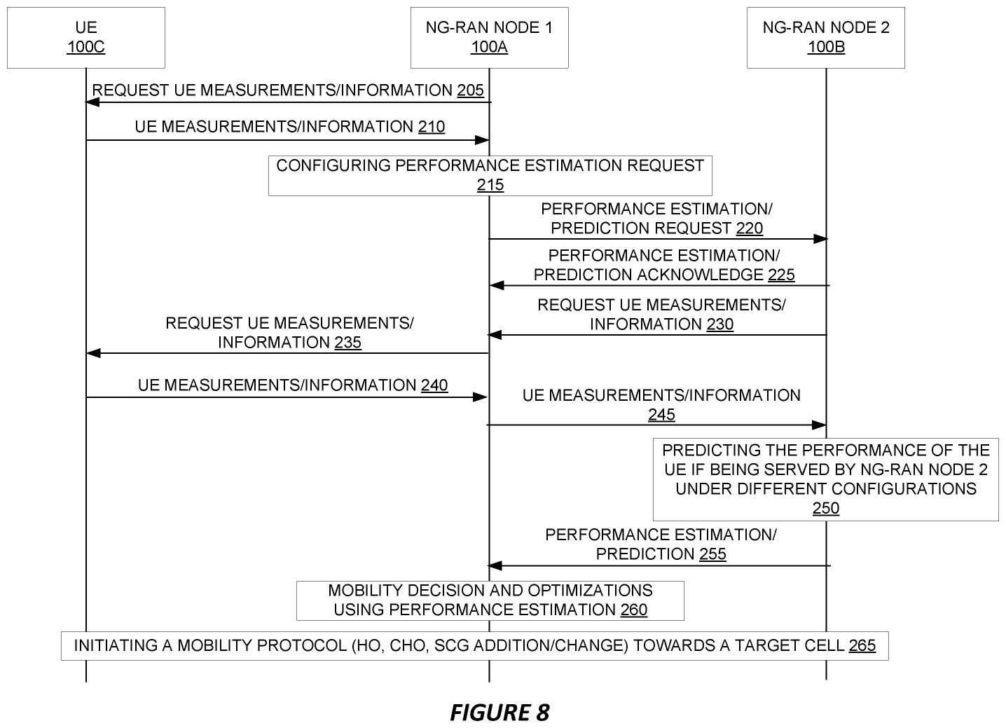

Consider now additional details of some embodiments as shown in FIG. 8. Similar to FIG. 4, NG-RAN node 1 (100A) exemplifies the source network node 14S, NG-RAN node 2 (100B) exemplifies a candidate target network node 14T, and UE 100C exemplifies the wireless communication device 12. As shown, NG-RAN node 1 (100A) transmits a request for UE measurements/information to the UE 100C (Step 205). The UE 100C responds with the UE measurements/information (Step 210).

NG-RAN node 1 (100A) configures a performance estimation/prediction request (Step 215), e.g., as an example of the request 22 in FIG. 3. NG-RAN node 1 (100A) sends this performance estimation/prediction request to the NG-RAN node 2 (100B) (Step 220).

NG-RAN node 2 (100B) in FIG. 8 may transmits a performance estimation/prediction acknowledgement to the NG-RAN node 1 (100A) (Step 225). Alternatively or additionally, NG-RAN node 2 (100B) transmits a corresponding request for UE measurements/information to NG-RAN node 1 (100A) (Step 230), which in turn relays the request to the UE 100C (Step 235). The UE 100C responds to the request with the UE measurements/information (Step 240), and NG-RAN node 1 (100A) relays the UE measurements/information to NG-RAN node 2 (100B) (Step 245).

Equipped with the UE measurements/information, NG-RAN node 2 (100B) predicts/estimates the performance of the UE if being served by NG-RAN node 2 (100B) under different configurations (Step 250). NG-RAN node 2 (100B) then sends this performance estimation/prediction to NG-RAN node 1 (Step 255).

NG-RAN node 1 (100A) performs a mobility decision and optimizations using the estimated/predicted performance (Step 260). That is, NG-RAN node 1 (100A) performs mobility optimization upon receiving a performance estimation by the neighbouring RAN node(s). Accordingly, NG-RAN node 1 (100A) as shown may select a target cell and initiate a mobility protocol (e.g., HO, CHO, SCG addition or change) towards the selected target cell (Step 265).

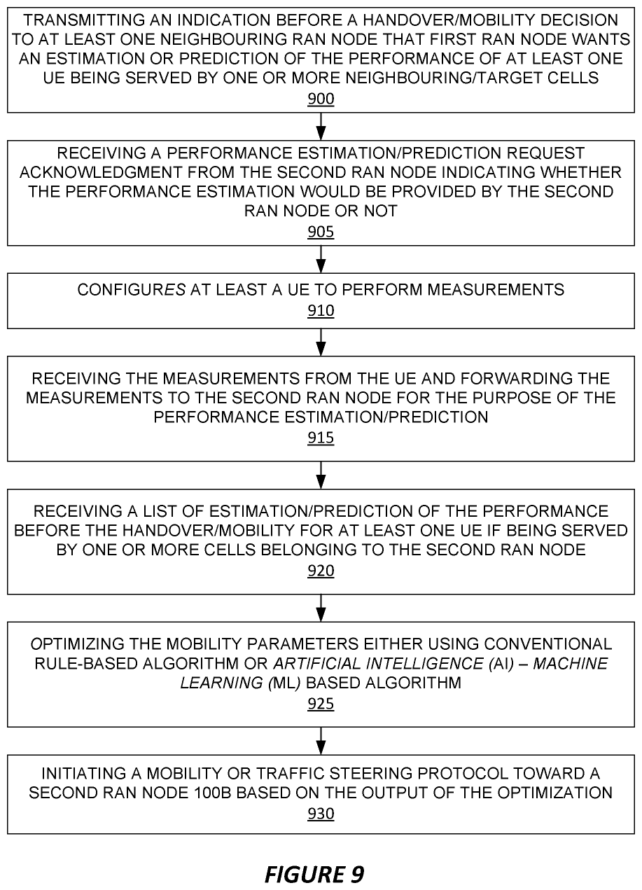

Generally, then, some embodiments herein include a method, performed by a first RAN node 100A, as shown in FIG. 9. The first RAN node 100A is an example of source network node 14S in FIG. 3. The method comprises, before a handover/mobility decision, transmitting, to at least one neighbouring RAN node, an indication that the first RAN node 100A wants an estimation or prediction of the performance of at least one UE 100C being served by one or more neighbouring/target cells.

In some embodiments, the at least one neighbouring RAN node includes a second RAN node 100B, e.g., an example of a candidate target network node 14T in FIG. 3.

In an embodiment, the UE(s) 100C is (are) still served by the first RAN node 100A, when the performance estimation request is sent to the neighbouring RAN node.

In one embodiment, the indication includes the UE(s) capabilities as well as the UE(s) radio measurements and other traffic/trajectory information.

In one embodiment, the indication includes a list of performance metrics requested by the serving RAN node. A non-limiting example of a list of performance metrics is explained above and below.

In one embodiment, the indication includes a list of the cells for which the performance estimation/prediction is requested.

In one embodiment, the indication includes a list of possible configurations under which the UEs' performance estimation/prediction is required.

In a non-limiting example, the indication can be transmitted using the Handover Request message (e.g., in a conditional handover scenario), or using a dedicated (to the performance estimation/prediction) signal.

In one embodiment, the indication includes a set of performance metrics values of which the predicted performance should be compared to. The performance metrics values can comprise a set of requirements, e.g., a certain throughput or latency requirement. Or it comprises the UE current QoS metrics, and the prediction comprises estimating whether the performance is above or below said QoS metrics.

In some embodiments, the indication is an example of the request 22 in FIG. 3.

In some embodiments, the method further comprises receiving a performance estimation/prediction request acknowledgment from the second RAN node 100B indicating whether the performance estimation would be provided by the second RAN node 100B or not (Block 905). In one embodiment, the performance estimation/prediction acknowledgement may include a list of performance metrics that the associated estimation/prediction information can be provided by the second RAN node 100B.

In a first option, consistent with that shown in FIG. 8, the method further comprises receiving a request from the second RAN node 100B. The request includes a measurement configuration for at least one UE to perform some measurement (e.g., radio measurement or QoS measurement) based on the measurement configuration provided by the second RAN node 100B. The request may include a list of cells or synchronization signal block (SSB) beams or channel state information reference signal (CSI-RS) beams that the second RAN node 100B is interested to collect the measurement from the UE 100C or the first RAN node 100A. In this first option, the method may further comprise, upon receiving a measurement request from second RAN node 100B, configuring at least one UE 100C to perform the requested measurements requested by the second RAN node 100B.

In a second option not shown in FIG. 8, before the handover/mobility for a UE 100C to a cell of the second RAN node 100B, the first RAN node 100A determines a list of cells or SSB beams or CSI-RS beams of the second RAN node 100B and/or UE performance estimation or prediction that the first RAN node 100A or the second RAN node 100B is interested in. This determining can be based on one or more of: (i) configuration data obtained by the first RAN node 100A; (ii) historical UE measurements received by the first RAN 100A for one or more cells or SSB beams or CSI-RS beams of the second RAN node 100B; or (iii) historical/cached measurement configurations received by the second RAN node 100B. In this second option, the first RAN node 100A correspondingly configures at least a UE 100C to perform measurements concerning a list of cells or SSB beams or CSI-RS beams of the second RAN node 100B.

In either the first or the second option, then, the method as shown in FIG. 9 includes configuring at least a UE 100C to perform measurements (Block 910).

Regardless, the method as shown further comprises receiving the measurements from the UE and forwarding the measurements to the second RAN node for the purpose of the performance estimation/prediction (Block 915).

The method may then further comprise receiving a list of estimation/prediction of the performance before the handover/mobility for at least one UE 100C if being served by one or more cells belonging to the second RAN node 100B (Block 920). In some embodiments, the estimation/prediction of the performance is an example of predicted information 20 in FIG. 3.

The method may also comprise optimizing the mobility parameters either using conventional rule-based algorithm or artificial intelligence (AI)-machine learning (ML) based algorithm (Block 925). In one or more such embodiments, the method comprises initiating a mobility or traffic steering protocol (handover, conditional handover, dual connectivity protocols such as SCG addition or SCG change) toward a second RAN node 100B based on the output of the optimization (Block 930).

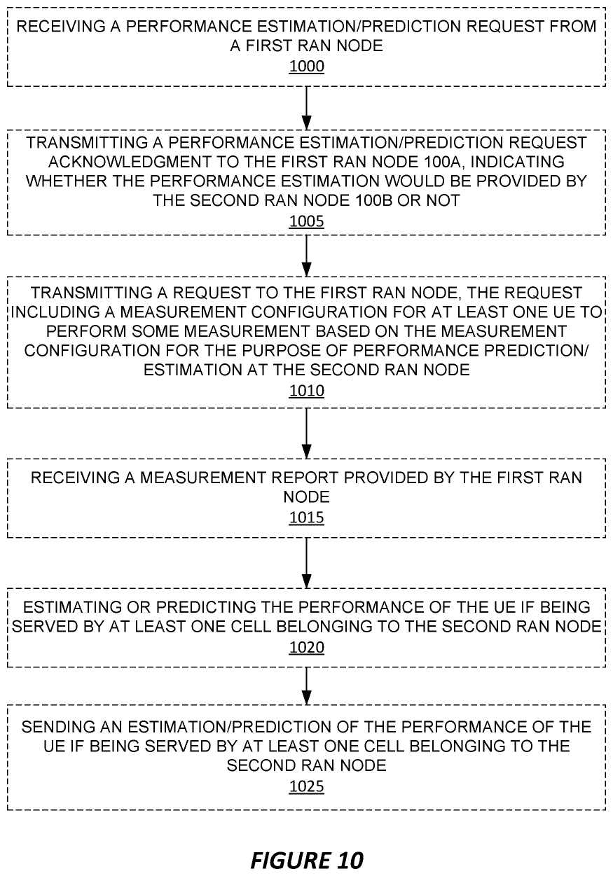

FIG. 10 shows a corresponding method performed by a second RAN node 100B. The second RAN node is an example of a candidate target network node 14T in FIG. 3.

In some embodiments, the method comprises receiving a performance estimation/prediction request from a first RAN node 100A (Block 1000).

In some embodiments, the indication includes the UE(s) capabilities as well as the UE(s) radio measurements and other traffic/trajectory information.

In some embodiments, the indication includes a list of performance metrics requested by the serving RAN node. A non-limiting example of a list of performance metrics is explained above.

In one embodiment, the indication includes a list of the cells for which the performance estimation/prediction is requested. Alternatively or additionally, the indication may include a list of configurations under which the UEs' performance estimation/prediction is required.

In a non-limiting example, the indication can be received over the Handover Request message (e.g., in a Conditional Handover scenario), or using a dedicated (to the performance estimation/prediction) signal.

The request may be an example of request 22 in FIG. 3.

In some embodiments, the method further comprises transmitting a performance estimation/prediction request acknowledgment to the first RAN node 100A, indicating whether the performance estimation would be provided by the second RAN node 100B or not (Block 1005).

In some embodiments, the method also comprises transmitting a request to the first RAN node, the request including a measurement configuration for at least one UE to perform some measurement (e.g., radio measurement or QoS measurement) based on the measurement configuration for the purpose of performance prediction/estimation at the second RAN node (Block 1010). The request may include a list of cells or SSB beams or CSI-RS beams that the second RAN node 100B is interested to collect measurements from the UE 100C or the first RAN node 100A.

In some embodiments, the method comprises receiving a measurement report provided by the first RAN node 100A (Block 1015). The measurement report comprises measurements performed by the UEs 100C or by the first RAN node 100A. In a first option, the measurement report is based on the measurement configuration(s) provided by the second RAN node 100B.

In some embodiments, the method also comprises estimating or predicting the performance of the UE if being served by at least one cell belonging to the second RAN node (Block 1020). The performance estimation/prediction can be done based on different cell/bearer/CA/DC configurations in different cells. The second RAN node 100B uses the measurement reports provided by the UE 100C and the first RAN node 100A as input for the estimation/prediction.

In some embodiments, the method also comprises sending the estimation/prediction of the performance of at least one UE 100C currently served by the first RAN node 100A if being served by at least one cell belonging to the second RAN node 100B (block 1025). The performance estimation/prediction can be listed based on different configuration in different cells. The performance estimation/prediction is an example of predicted information 20 in FIG. 3.

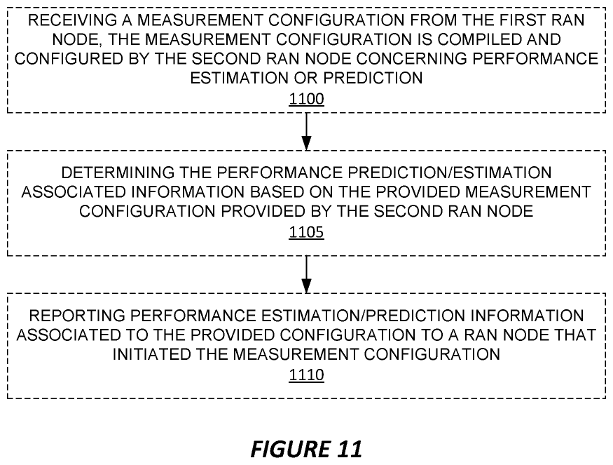

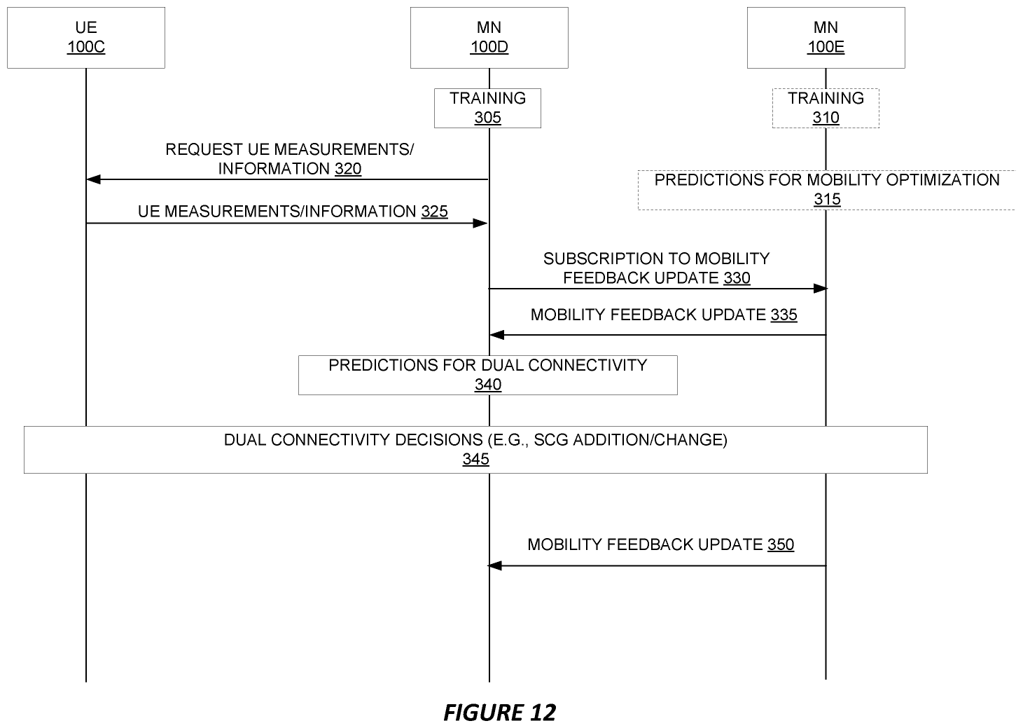

FIG. 11 shows a method performed by a wireless terminal (also called User Equipment-UE) being served by a cell belonging to the first RAN node 100A. The first RAN node 100A is an example of source network node 14S in FIG. 3. The wireless terminal is an example of wireless communication device 12 in FIG. 3.

The method comprises receiving a measurement configuration from the first RAN node 100A, where the measurement configuration is compiled and configured by the second RAN node 100B concerning performance estimation or prediction (Block 1100).

At least one of the following measurement configurations can be received. In some embodiments, the measurement configuration is a radio link measurement and/or predictions of cells belonging to the second RAN node 100B, in given frequencies (intra or inter frequency measurements). This may include configuration of the measurement (periodic, event based), a measurement period, a measurement of the cells may include cell level and beam level measurements of SSB or CSI-RS beams, such as beam Index/identifier of the measurement beam. Alternatively or additionally, the measurement configuration may configure quality of service (QOS) and/or quality of experience (QoE) related measurements (wherein QoE measurements can be in a form non-interpretable by RAN or in a form interpretable by RAN (aka RAN visible QoE)) and predictions for the following metrics: delay, throughput, jitter, buffer level, and/or prediction intervals.

The method as shown further comprises determining the performance prediction/estimation associated information based on the provided measurement configuration provided by the second RAN node (Block 1110). This may encompass, for example, performing measurements, including available information in a report, logging available information in a UE variable, etc.

The method also comprises reporting performance estimation/prediction information associated to the provided configuration to a RAN node that initiated the measurement configuration, here either source or neighbouring RAN node (Block 1110).

In another embodiment, the source RAN node requests to a target RAN node whether a UE with given characteristics, for example with characteristics explained above, may receive a performance above or below a certain threshold, once the UE is served by one of the cells of the target RAN node.

The performance thresholds may be thresholds for one or more of the following parameters: (i) threshold on throughput, delay, jitter, packet losses, on a cumulative basis, per service basis, per DRB (Data Radio Bearer) basis, per PDU Session basis, per slice basis, per QoS class basis (e.g., per 5QI), or per servingPLMN basis; (ii) threshold on energy consumption for the RAN, for example as a delta change with respect to the energy consumption at the RNA before mobility; (iii) threshold on energy consumption for the UE once at the target cell; or (iv) indication of whether the UE will be served via specific configurations such dual connectivity (DC) or with carrier aggregation (CA).

### Non-Limiting Examples of Performance Estimation/Prediction Metrics

Some embodiments herein enable a request for performance estimation/prediction at the neighboring RAN node. The performance metrics, as an example of predicted information 20, may comprise at least one of the following.

The performance metrics may include UE quality of service estimation/prediction in Uplink/Downlink if being served by a cell belonging to the second RAN node 100B. For example, (i) average, mean, median, maximum or instantaneous throughput in uplink or downlink; (ii) average, mean, median, maximum or instantaneous delay in uplink or downlink; (iii) average, mean, median, maximum or instantaneous jitter in uplink or downlink; (iv) average, mean, median, maximum or instantaneous packet error rate; (v) average, mean, median, maximum or instantaneous block error rate (BLER); (vi) UE traffic pattern per service type after handover (HO) (vii) all or any combination of the above metrics per each serving cell of the second RAN node 100B; (viii) all or any combination of the above metrics per UE configuration (e.g., per each carrier aggregation or dual connectivity); (ix) all or any combination of the above metrics for each service type running by UE, e.g., enhanced mobile broadband (eMBB), Multimedia Telephony Service for IMS (MTSI), virtual reality (VR), augmented reality (AR), Multimedia Broadcast Multicast Service (MBMS), voice over Internet Protocol (VOIP), ultra reliable low latency communication (URLLC), online gaming, etc.

The performance metrics may include UE radio link quality estimation/prediction if the UE being served by a cell belonging to the second RAN node 100B.

The performance metrics can include radio link measurement and/or predictions of cells belonging to the second RAN node 100B, in given frequencies (intra or inter frequency measurements). Measurement of the cells may include cell level and beam level measurements of SSB or CSI-RS beams, such as (i) beam Index/identifier of the measurement beam; (ii) all or any combination of the above metrics per each serving cell of the second RAN node 100B; or (iii) all or any combination of the above metrics per UE configuration (e.g., per each carrier aggregation or dual connectivity).

In some embodiments, the performance metrics may include estimation/prediction of the UE dwelling time in at least one cell belonging to the second RAN node. The prediction/estimation can comprise (i) average, mean, median, maximum dwelling time at any of the cell belonging to the second RAN node 100B; or (ii) average, mean, median, maximum dwelling time at any RRC state (e.g., RRC_Connected or RRC_Inactive or RRC_Idle mode) any of the cell belonging to the second RAN node 100B.

Alternatively or additionally, the performance metrics may include estimation/prediction of the physical resource blocks (PRBs) used by the UE if being served by a cell belonging to the second RAN node 100B.

The performance metrics may include UE quality of service estimation/prediction in Uplink/Downlink if being served by a cell belonging to the second RAN node 100B: (i) average, mean, median, maximum or instantaneous throughput at the application layer in uplink or downlink; (ii) average, mean, median, maximum or instantaneous delay at the application layer in uplink or downlink; (iii) average, mean, median, maximum or instantaneous jitter at the application layer in uplink or downlink; (iv) UE traffic pattern after HO at the application layer; (v) all or any combination of the above metrics per each serving cell of the second RAN node 100B; (vi) all or any combination of the above metrics per UE configuration (e.g., per each carrier aggregation or dual connectivity); (vii) all or any combination of the above metrics for each service type running by UE, e.g., eMBB, MTSI, VR, AR, MBMS, VOIP, URLLC, online gaming, etc.

The prediction performance can be reported as a probability density function (PDF). Since typically two key performance indicators (KPIs) are correlated, it could be reported as a two dimensional-PDF. For example, bitrate vs latency.

Update Performance Prediction Model after Handover

The NG-RAN node 2 can, after the UE mobility event, update the performance prediction model based on the actual UE experienced QoS.

### EXAMPLE IMPLEMENTATION

In a non-limiting example, some embodiments herein can be implemented in the inter-RAN node Technical Specification, e.g., TS 38.423 V16.7.0 using a dedicated signal as shown in the following:

### UE Performance Estimation/Prediction Request

This message is sent by NG-RAN node₁ to NG-RAN node₂ to initiate the requested measurement according to the parameters given in the message. This request exemplifies the request 22 in FIG. 3.

Direction: NG-RAN node₁® NG-RAN node₂.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| NG-RAN node1 | M | | INTEGER | Allocated by NG- | YES | reject |
| Measurement ID | | | (1 . . . 4095, . . .) | RAN node₁ | | |
| NG-RAN node2 | O | | INTEGER | Allocated by NG- | YES | ignore |
| Measurement ID | | | (1 . . . 4095, . . .) | RAN node₂ | | |
| Registration | M | | ENUMERATED | Type of request | YES | reject |
| Request | | | (start, stop, | for which the | | |
| | | | add, . . .) | performance | | |
| | | | | estimation is | | |
| | | | | required. | | |
| Report | C- | | BITSTRING | Each position in | YES | reject |
| Characteristics | ifRegistrationRe- | | (SIZE(32)) | the bitmap | | |
| | questStart | | | indicates | | |
| | | | | estimation/ | | |
| | | | | prediction object the | | |
| | | | | NG-RAN node2 | | |
| | | | | is requested to | | |
| | | | | report. | | |
| | | | | First Bit = radio | | |
| | | | | link quality, | | |
| | | | | Second Bit = | | |
| | | | | throughput per | | |
| | | | | service type, | | |
| | | | | Third Bit = | | |
| | | | | PRB allocation to | | |
| | | | | the UE | | |
| Cell To Report | | 0 . . . 1 | | Cell ID list to | YES | ignore |
| List | | | | which the | | |
| | | | | request applies. | | |
| >Cell To Report | | 1 . . . | | | — | |
| Item | | <maxnoofCellsinNG- | | | | |
| | | RANnode> | | | | |
| >>Cell ID | M | | Global NG-RAN | | — | |
| | | | Cell Identity | | | |
| | | | 9.2.2.27 | | | |
| >>SSB To | | 0 . . . 1 | | SSB list to which | — | |
| Report List | | | | the request | | |
| | | | | applies. | | |
| >>>SSB To | | 1 . . . | | | | |
| Report Item | | <maxnoofSSBAreas> | | | | |
| >>>>SSB- | M | | INTEGER | | — | |
| Index | | | (0 . . . , 63 . . .) | | | |
| >>Slice To | | 0 . . . 1 | | S-NSSAI list to | — | |
| Report List | | | | which the | | |
| | | | | request applies. | | |
| >>>Slice To | | 1 . . . | | | — | |
| Report Item | | <maxnoofBPLMNs> | | | | |
| >>>>PLMN | M | | 9.3.1.14 | Broadcast PLMN | — | |
| Identity | | | | | | |
| >>>>S- | | 1 | | | — | |
| NSSAI List | | | | | | |
| >>>>>S- | | 1 . . . | | | — | |
| NSSAI | | <maxnoofSliceItems> | | | | |
| Item | | | | | | |
| >>>>>>S- | M | | S-NSSAI | | — | |
| NSSAI | | | 9.3.1.38 | | | |
| UE | O | 0 . . . 1 | | | | |
| measurement | | | | | | |
| report list | | | | | | |
| UE measurement | | 1 . . . | | | | |
| report item | | <maxnoofUEsToPredictPer- | | | | |
| | | formance> | | | | |
| UE measurement | O | | Measurement | | | |
| report | | | report provided | | | |
| | | | by the UEs as | | | |
| | | | specified in TS | | | |
| | | | 38.331 | | | |

| Condition | Explanation |
|---|---|
| ifRegistrationRequestStart | This IE shall be present if the |
| | Registration Request IE is set to the |
| | value “start”. |

| Range bound | Explanation |
|---|---|
| maxnoofCellsinNG-RANnode | Maximum no. cells that can be served |
| | by a NG-RAN node. Value is 16384. |
| maxnoofSSBAreas | Maximum no. SSB Areas that can be |
| | served by a NG-RAN node cell. |
| | Value is 64. |
| maxnoofSliceItems | Maximum no. of signalled slice |
| | support items. Value is 1024. |
| maxnoofUEsToPredictPer- | Maximum number of the UEs NG-RAN |
| formance | node 1 wants the NG-RAN node 2 to |
| | predict their performance before a |
| | handover or a dual connectivity |
| | operation. |

### UE Performance Estimation/Prediction Response

This message is sent by NG-RAN node₂ to NG-RAN node₁ to indicate that the request to report UE performance estimation/prediction performed at the NG-RAN node₂ is successfully initiated.

Direction: NG-RAN node₂® NG-RAN node₁.

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message | M | 9.2.3.1 | | YES | reject |
| Type | | | | | |
| NG-RAN | M | INTEGER | Allocated by | YES | reject |
| node1 | | (1 . . . | NG-RAN | | |
| Measurement | | 4095, . . .) | node₁ | | |
| ID | | | | | |
| NG-RAN | M | INTEGER | Allocated by | YES | reject |
| node2 | | (1 . . . | NG-RAN | | |
| Measurement | | 4095, . . .) | node₂ | | |
| ID | | | | | |
| Criticality | O | 9.2.3.3 | | YES | ignore |
| Diagnostics | | | | | |

### UE Performance Estimation/Prediction Failure

This message is sent by NG-RAN node₂ to NG-RAN node₁ to indicate that the request to report UE performance estimation/prediction performed at the NG-RAN node2 cannot be initiated

Direction: NG-RAN node₂® NG-RAN node1.

| | | | | | | |
|---|---|---|---|---|---|---|
| IE/Group | | | IE type and | Semantics | | Assigned |
| Name | Presence | Range | reference | description | Criticality | Criticality |

| | | | | | |
|---|---|---|---|---|---|
| Message | M | 9.2.3.1 | | YES | reject |
| Type | | | | | |
| NG-RAN | M | INTEGER | Allocated by | YES | reject |
| node1 | | (1 . . . | NG-RAN | | |
| Measurement | | 4095, . . .) | node₁ | | |
| ID | | | | | |
| NG-RAN | M | INTEGER | Allocated by | YES | reject |
| node2 | | (1 . . . | NG-RAN | | |
| Measurement | | 4095, . . .) | node₂ | | |
| ID | | | | | |
| Cause | M | 9.2.3.2 | | YES | ignore |
| Criticality | O | 9.2.3.3 | | YES | ignore |
| Diagnostics | | | | | |

### UE Performance Estimation/Prediction Update

This message is sent by NG-RAN node₂ to NG-RAN node₁ to report the results of the UE performance estimation/prediction performed at the NG-RAN node2. The results of the UE performance estimation/prediction, i.e., the content of this message, is an example of the predicted information 20 in FIG. 3. Direction: NG-RAN node₂® NG-RAN node₁.

| IE/Group | | | IE type and | Semantics | | Assigned |
|---|---|---|---|---|---|---|
| Name | Presence | Range | reference | description | Criticality | Criticality |
| Message Type | M | | 9.2.3.1 | | YES | ignore |
| NG-RAN node1 | M | | INTEGER | Allocated by | YES | reject |
| Measurement ID | | | (1 . . . | NG-RAN | | |
| | | | 4095, . . .) | node₁ | | |
| NG-RAN node2 | M | | INTEGER | Allocated by | YES | reject |
| Measurement ID | | | (1 . . . | NG-RAN | | |
| | | | 4095, . . .) | node₂ | | |
| UE | M | 1 | | | | |
| performance | | | | | | |
| estimation/ | | | | | | |
| prediction | | | | | | |
| result list | | | | | | |
| UE | | 1 . . . | | | | |
| performance | | <maxnoofUEsToPre- | | | | |
| estimation/ | | dictPerformance> | | | | |
| prediction result | | | | | | |
| Item | | | | | | |
| >Cell | | 1 | | | YES | ignore |
| Measurement | | | | | | |
| Result | | | | | | |
| >>Cell | | 1 . . . | | | YES | ignore |
| Measurement | | <maxnoofCellsinNG- | | | | |
| Result Item | | RANnode> | | | | |
| >>>Cell ID | M | | Global NG- | | — | |
| | | | RAN Cell | | | |
| | | | Identity | | | |
| | | | 9.2.2.27 | | | |
| >>>Radio | O | | | | — | |
| measurement | | | | | | |
| prediction | | | | | | |
| at a target | | | | | | |
| cell | | | | | | |
| >>>QoS | O | | | | — | |
| parameters | | | | | | |
| prediction - | | | | | | |
| e.g., | | | | | | |
| throughput | | | | | | |
| prediciton | | | | | | |
| >>>QoE | O | | | | — | |
| parameters | | | | | | |
| prediction, | | | | | | |
| e.g., buffer | | | | | | |
| level | | | | | | |
| prediciton | | | | | | |
| >>> PRB | O | | | | | |
| allocation | | | | | | |
| prediction | | | | | | |

| Range bound | Explanation |
|---|---|
| maxnoofCellsinNG-RANnode | Maximum no. cells that can be served |
| | by a NG-RAN node. Value is 16384. |

In another non-limiting example, the above information can be signaled by the existing signaling, e.g., Handover Request message can be used to convey the request for performance estimation/prediction for a single UE (i.e., UE associated signaling) from the first NG-RAN node to the second NG-RAN node and the Handover Request Acknowledge can be used to convey the performance estimation/prediction information from the second NG-RAN node to the first NG-RAN node.

Consider now artificial intelligence/machine learning (ML) aspects when predicting the information. Machine learning (ML) can be used to find a predictive function for a given dataset; the dataset is typically a mapping between a given input to an output. The predictive function (or mapping function) is generated in a training phase, where the training phase assumes knowledge of both the input and output. The execution phase comprises predicting the output for a given input.

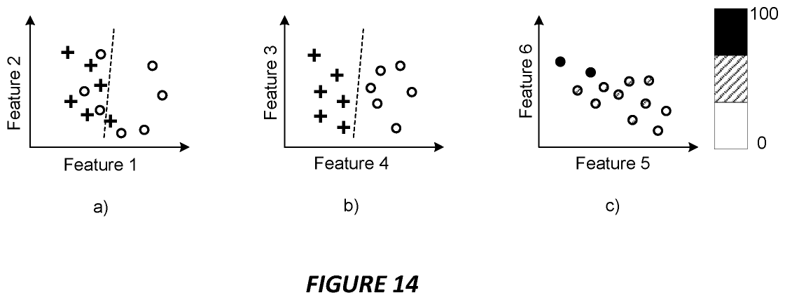

FIG. 14 shows an example of one type of machine learning, namely classification in figure a and b, where the task is to train a predictive function that separates the two classes (circle and cross class). In FIG. 14a, feature 1 and 2 provides low separation of the output class, hence leading to a worse prediction performance in comparison with FIG. 14b, where using feature 3 and 4 enables a better separation and classifying performance. FIG. 14c shows another type of ML problem, namely regression, where the task is to train a predictive function that predicts a value (continuous value between 0-100 in this example) based on its input features. In general, the performance of the machine learner is proportional to the correlation between the input and the output. Key problems in machine learning relate to finding/creating good features and collecting enough data samples. Another problem related to ML in wireless networks is when features and class labels are located at different network nodes, for example at different gNBs.

Consider now additional details of some AI/ML based embodiments. Use cases for such embodiments include mobility optimization, traffic steering, energy saving, load balancing, optimization of physical layer parameters, etc. Some embodiments herein address the signalling solutions for the measurement collection from the UE and the neighbouring RAN nodes for the mobility procedures to enhance the performance of the AI/ML based traffic steering function.

It is noticed that information exchange over various signalling interfaces (XnAP, X2AP, F1AP, E1AP) may increase awareness at the gNBs of neighbour cells load, coverage and capacity aspects. Such awareness becomes very useful when designing solutions based on AI/ML. In light of that, some embodiments address how provided measurements by UE and the neighbouring RAN nodes of the mobility procedures can assist the network to enhance the performance of the AI/ML based mobility optimization functions, in particular handover procedure and dual connectivity procedures as explained in the following.

Mobility procedures in NR (handover and dual connectivity) are heretofore carried out without taking into account the UEs experience after successful execution of the procedures. Such procedures can be enhanced by increasing RAN awareness about UE performance at the target cell. This would allow the source gNB to not only evaluate whether a target cell is good from a radio point of view (e.g., before handover execution) but also to consider quality of service and user experience after successful mobility to the target cell.

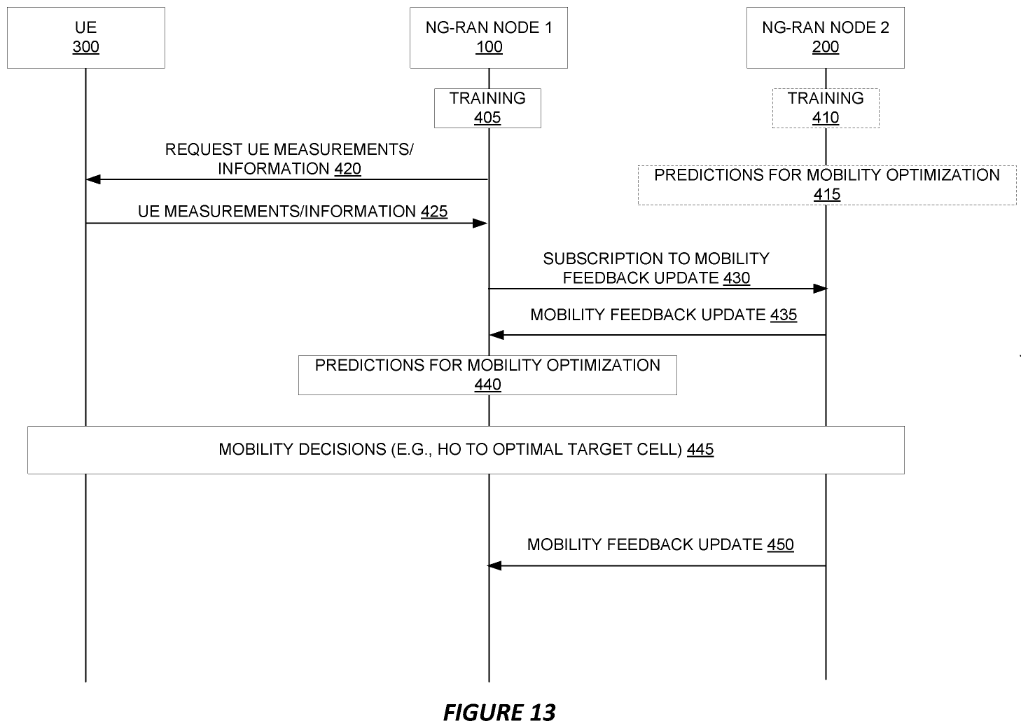

In some embodiments, the source RAN node not only can get measurements from the served UEs but also can subscribe to the neighbour RAN nodes requesting for specific feedback that assist the serving node for a better mobility decision. Performance feedback received from the neighbouring RAN nodes, can be used as input to an AI/ML function supporting traffic related decisions (e.g. selection of target cell in case of mobility). Given that these inputs show the performance of the UE at the target, they can improve traffic steering decisions towards cells where performance is maximised. An example of high-level signalling flow for the case described is shown in FIG. 13.

By means of this procedure, NG-RAN node 1 can obtain estimated performance of the UE and feedback information including the measurements and UE configuration from NG-RAN node 2. The steps of the message sequence chart in FIG. 13 are described here.

Step 305. NG-RAN node1 trains the AI-ML mode based on the collected data and inputs received from the UEs and the neighbouring nodes.

Step 310 and 320. NG-RAN node 1 configures the measurement information on the UE side and sends configuration message to UE requesting for radio measurement, as well as traffic and trajectory related information.

Step 325. UE collects the indicated measurement, e.g., radio related measurements such as RSRP, RSRQ, SINR of serving cell and neighbouring cells, UE traffic related information such as predicted data rate, packet size, packet delay, next packet arrival time, and the UE trajectory assistance information (e.g., UE speed, UE location, etc.). The UE sends measurement report message to NG-RAN node1 including the required measurement.

Step 330. NG RAN node 1 subscribes to the Mobility Feedback Update of the neighbouring NG RAN nodes.

Step 335. NG RAN node 1 receives the Mobility Feedback Update from the neighbouring NG RAN nodes. The Mobility Feedback Update contains information including the measurements (e.g. throughput, latency, radio link quality, cell dwelling time) and the UE configurations (e.g., dual connectivity, carrier aggregation).

Step 340. NG RAN node 1 performs predictions for mobility optimization. Required measurements are leveraged into Model Inference to output the prediction, including e.g., UE trajectory prediction, target cell prediction, target NG-RAN node prediction, etc.

Step 345. According to the prediction, recommended actions are executed for Mobility Optimization e.g., handover toward NG RAN node 2.

Step 350. NG RAN node 1 receives Mobility Feedback Update concerning the handed over UE from the NG RAN node 2.

With the assistance information received from NG-RAN node 2, NG-RAN node 1 is able to take a better decision on the mobility target to choose in a future mobility event. Such decision can be supported by an AI/ML process that may predict the best mobility target cell also on the basis of past performance of the UE at the target

Similarly, before triggering the addition of a Secondary gNB, an MN-gNB could benefit of receiving feedback from the SN node concerning UE performance upon dual connectivity procedures such as SN Addition/Change.

In some embodiments in this regard, the MN RAN node can subscribe to the neighbour RAN nodes, requesting for specific feedback. Performance feedback received from the neighbouring RAN nodes, can be used as input to an AI/ML function supporting traffic related decisions (e.g. optimal selection of SN node or SCG). Given that these inputs show the estimated/predicted performance of the UE at the SN, they can improve traffic steering decisions towards cells where performance is maximised. An example of high-level signalling flow for the case described is shown in FIG. 13.

By means of this procedure, NG-RAN node 1 can obtain mobility feedback information including the measurements, predicted/estimated performance and possible UE configuration from NG-RAN node 2. The steps of the message sequence chart in FIG. 13 are described here.

Step 405. MN trains the AI-ML mode based on the collected data and inputs received from the UEs and the neighbouring nodes.

Step 420. MN configures the measurement information on the UE side and sends configuration message to UE requesting for radio measurement, as well as traffic and trajectory related information.

Step 425. The UE collects the indicated measurement, e.g., radio related measurements such as RSRP, RSRQ, SINR of serving cell and neighbouring cells, UE traffic related information such as predicted data rate, packet size, packet delay, next packet arrival time, and the UE trajectory assistance information (e.g., UE speed, UE location, etc.). The UE sends measurement report message to MN including the required measurement.

Step 430. MN subscribes to the Mobility Feedback Update of the neighbouring NG RAN nodes (here SN).

Step 435. MN receives the Mobility Feedback Update from the neighbouring NG RAN nodes including SN. The Mobility Feedback Update contains information including the measurements (e.g. throughput, latency, radio link quality, cell dwelling time) and the UE configurations (e.g., dual connectivity, carrier aggregation).

Step 440. MN performs predictions for mobility optimization. Required measurements are leveraged into Model Inference to output the prediction, including e.g., UE trajectory prediction, target cell prediction, target NG-RAN node prediction, etc.

Step 445. According to the prediction, recommended actions for dual connectivity are executed toward SN.

Step 450. MN receives Mobility Feedback Update concerning the handed over UE from the SN.

Table 1 shows some of the measurements required from the UE and the target RAN node (or the SN) to enhance the mobility decisions in AI/ML algorithms according to some embodiments.

TABLE 1: Performance feedback information and measurements from target cell or PSCell

| UE side measurements | Network side measurements |
|---|---|
| Trajectory information | Traffic steering configuration |
| (e.g. speed, position, etc.) | used for the UE e.g., multi- |
| Assistance Information on Traffic | connectivity and carrier |
| Quality of experience e.g., | aggregation |
| buffer level | Load information |
| Successful HO measurements | DL/UL throughput |
| Radio link failure information | DL/UL latency |
| Mobility history information | Cell dwelling time |
| Moving velocity | UE history information |

UE side measurements: A RAN node can request and obtain UE assistance information on traffic and trajectory, based on real end-user behaviour. This provides RAN with insights on the traffic and direction of the UEs in the future. This mechanism implies configuring a UE to collect and report such over RRC protocol.

Network side measurements: A target RAN node (or the SN) can also measure performance related metrics such as throughput and packet delay for the UEs. In addition, the target RAN node (or the SN) can feedback the configurations used for the UE while the UE was dwelling at the target cell (or PSCell). Finally, UEs provided measurements and the RAN measurements can be compiled and signalled to the source RAN node (or the MN). This second mechanism has an impact on RA12 protocols, such as XnAP, X2AP, NGAP.

Some embodiments herein propose the following modifications to TR37.817:

Mobility management is the scheme to guarantee the service-continuity during the mobility by minimizing the call drops, radio link failures (RLFs), unnecessary handovers, and ping-pong. For the future high-frequency network, as the coverage of a single node decreases, the frequency for UE to handover between nodes becomes high, especially for high-mobility UE. In addition, for the applications characterized with the stringent QoS requirements such as reliability, latency etc., the QoE is sensitive to the handover performance, so that mobility management should avoid unsuccessful handover and reduce the latency during handover procedure. However, for the conventional method, it is challengeable for trial-and-error-based scheme to achieve nearly zero-failure handover. The unsuccessful handover cases are the main reason for packet dropping or extra delay during the mobility period, which is unexpected for the packet-drop-intolerant and low-latency applications. In addition, the effectiveness of adjustment based on feedback may be weak due to randomness and inconstancy of transmission environment. Besides the baseline case of mobility, areas of optimization for mobility include dual connectivity, CHO, and DAPS, which each have additional aspects to handle in the optimization of mobility.

Mobility aspects of SON that can be enhanced by the use of AI/ML include reduction of the probability of unintended events, UE Location/Mobility/Performance prediction, and traffic Steering.

Reduction of the Probability of Unintended Events Associated with Mobility.

Examples of such unintended events are Intra-system Too Late Handover, Intra-system Too Early Handover, and Intra-system Handover to Wrong Cell.

Regarding Intra-system Too Late Handover: A radio link failure (RLF) occurs after the UE has stayed for a long period of time in the cell; the UE attempts to re-establish the radio link connection in a different cell.

Regarding Intra-system Too Early Handover: An RLF occurs shortly after a successful handover from a source cell to a target cell or a handover failure occurs during the handover procedure; the UE attempts to re-establish the radio link connection in the source cell.

Regarding Intra-system Handover to Wrong Cell: An RLF occurs shortly after a successful handover from a source cell to a target cell or a handover failure occurs during the handover procedure; the UE attempts to re-establish the radio link connection in a cell other than the source cell and the target cell.

RAN Intelligence could observe multiple HO events with associated parameters, use this information to train its ML model and try to identify sets of parameters that lead to successful HOs and sets of parameters that lead to unintended events.

### UE Location/Mobility/Performance Prediction

Predicting UE's location is a part for mobility optimisation, as many radio resource management (RRM) actions related to mobility (e.g. selecting handover target cells) can benefit from the predicted UE location/trajectory. UE mobility prediction is also one factor in the optimization of early data forwarding, particularly for CHO. UE Performance prediction when the UE is served by certain cells is a factor in determining which is the best mobility target for maximisation of efficiency and performance.

### Traffic Steering

Efficient resource handling can be achieved adjusting handover trigger points and selecting optimal combination of PCell/PSCell/SCells to serve a user.

Existing traffic steering can also be improved by providing a RAN node with information related to mobility or dual connectivity.

For example, before initiating a handover, the source gNB could use feedbacks on UE performance collected for successful handovers occurred in the past and received from neighbouring gNBs.

Similarly, for the case of dual connectivity, before triggering the addition of a secondary gNB or triggering SN change, an eNB could use information (feedbacks) received in the past from the gNB for successfully completed SN Addition or SN Change procedures.

In the two reported examples, the source RAN node of a mobility event, or the RAN node acting as Master Node (a eNB for EN-DC, a gNB for NR-DC) can use feedbacks received from the other RAN node, as input to an AI/ML function supporting traffic related decisions (e.g. selection of target cell in case of mobility, selection of a PSCell/SCell(s) in the other case), so that future decisions can be optimized.

### Solutions and Standard Impacts

Considering the locations of AI/ML Model Training and AI/ML Model Inference for mobility solution, following two options are considered: (i) The AI/ML Model Training function is deployed in OAM, while the Model Inference function resides within the RAN node; (ii) Both the AI/ML Model Training function and the AI/ML Model Inference function reside within the RAN node.

In case of CU-DU split, Model Inference can be in the gNB-CU.

To improve the mobility decisions at a gNB (gNB-CU), a gNB can request mobility feedback from a neighbouring node.

AI/ML Model Training in OAM and AI/ML Model Inference in NG-RAN node

Step 1: The RAN is assumed to have in use a trained AI/ML model for inference

Step 2. Model Inference. Required measurements are leveraged into Model Inference to output the prediction, e.g. UE trajectory prediction, target cell prediction, target NG-RAN node prediction, etc.

Step 3. According to the prediction, recommended actions or configuration are executed for Mobility Optimization.

In some embodiments, the following data is required as input data for mobility optimization.

Input Information from UE: (i) UE historical location information from MDT, e.g., Latitude, longitude, altitude, cell ID; (ii) Radio measurements related to serving cell and neighbouring cells associated with UE location information, e.g., RSRP, RSRQ, SINR; (iii) UE Mobility history information; (iv) Moving velocity; (v) predicted traffic; (vi) Trajectory information; (vii) RAN visible QoE metrics e.g., buffer level.

Input Information from the neighbouring RAN nodes: (i) UE's successful handover information in the past and received from neighboring RAN nodes; (ii) UE's history information from neighbor; (iii) UEs' Position and trajectory, resource status, QoS parameters of historical HO-ed UE (e.g., loss rate, delay, throughput, etc.); (iv) Resource status and utilization prediction/estimation; (v) SON Reports of handovers that are successful handover report, too-early, too-late, or handover to wrong (sub-optimal) cell; (vi) Information about the performance of handed over UEs; (vii) UE performance prediction/estimation; (vii) UE dwelling time per cell; (viii) RAN visible QoE metrics e.g., buffer level.

Input Information from the local node: (i) UE trajectory prediction output (will be used by the RAN node internally); (ii) Local load prediction.

If existing UE measurements are needed by a gNB for AI/ML-based mobility optimization, the existing framework (including MDT and RRM measurements) may be reused.

Output data: (i) UE trajectory prediction (Latitude, longitude, altitude of UE over a future period of time); (ii) Estimated arrival probability in CHO and relevant confidence interval; (iii) Predicted handover target node, candidate cells in CHO, may together with the confidence of the predication.

Note that the term handover is used herein to include a reconfiguration with sync, i.e., a procedure where the UE receives a message (and/or applies a message) from the network (e.g., RRCReconfiguration including a reconfigurationWithSync in a CellGroupConfig), and, upon reception, performs random access to a target cell followed by the transmission of an RRCReconfigurationComplete like message. Hence, embodiments herein may be applicable upon other types of reconfiguration procedures such as the following.

One type of reconfiguration procedure may be a PSCell addition (i.e., throughput measurements when a PSCell is being added). In this case, the source node 32 described above can be a Master Node (MN) gNodeB or eNodeB.

Another type of reconfiguration procedure is a PSCell change (i.e., throughput measurements when a PSCell is being changed, in the same Secondary node and/or in a different Secondary node). In this case, the source node 32 described above can be a source Secondary Node (s-SN) gNodeB or eNodeB, while the target node 34 can be a target Secondary Node (SN) (t-SN).

Yet another type of reconfiguration procedure is a Conditional Handover (CHO) (i.e., throughput measurements when UE executes CHO towards a target cell).

Another type of reconfiguration procedure is a Conditional PSCell Addition (i.e., throughput measurements when a PSCell is being added). In this case, the source node 32 described above can be a Master Node (MN) gNodeB or eNodeB.

A further type of reconfiguration procedure is a Conditional PSCell Change (i.e., throughput measurements when a PSCell is being changed, in the same Secondary node and/or in a different Secondary node). In this case, the source node 32 described above can be a source Secondary Node (s-SN) gNodeB or eNodeB, while the target node 34 can be a target SN (t-SN), which could be a target candidate that becomes a target upon execution.

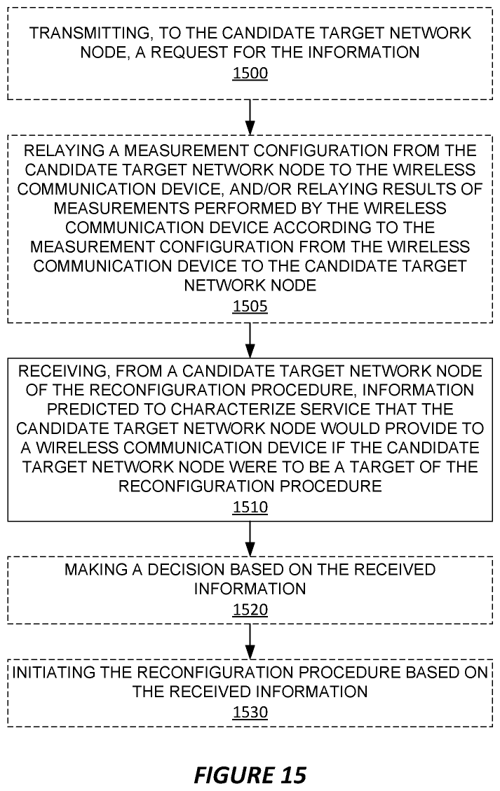

With reference to FIG. 3, FIG. 15 depicts a method performed by a network node configured to operate as a source network node 14S of a reconfiguration procedure 18 in accordance with particular embodiments. The method includes receiving, from a candidate target network node 14T of the reconfiguration procedure 18, information 20 predicted to characterize service that the candidate target network node 14T would provide to a wireless communication device 12 if the candidate target network node 14T were to be a target of the reconfiguration procedure 18 (Block 1510).

In some embodiments, the information 20 is predicted to characterize a performance of service that the candidate target network node 14T would provide to a wireless communication device 12 if the candidate target network node 14T were to be a target of the reconfiguration procedure 18. In some embodiments, the information 20 is predicted to characterize the performance in terms of one or more of throughput, delay, jitter, packet error rate, block error rate, or traffic pattern. In some embodiments, the information 20 is predicted to characterize the performance at an application layer. In some embodiments, the information 20 is predicted to characterize the performance in terms of one or more radio signal measurements. In some embodiments, the information 20 is predicted to characterize the performance at a physical layer. In some embodiments, the information 20 indicates whether the performance of service, that the candidate target network node 14T would provide to a wireless communication device 12 if the candidate target network node 14T were to be a target of the reconfiguration procedure 18, is predicted to be above or below a specified threshold.

In some embodiments, the information 20 is predicted to characterize a duration of time for which the candidate target network node 14T would provide service to a wireless communication device 12 if the candidate target network node 14T were to be a target of the reconfiguration procedure 18. In some embodiments, the information 20 is predicted to characterize the duration of time in terms of a device dwelling time in the candidate target network node 14T.

In some embodiments, the information 20 is predicted to characterize energy consumption attributable to service that the candidate target network node 14T would provide to a wireless communication device 12 if the candidate target network node 14T were to be a target of the reconfiguration procedure 18. In some embodiments, the information 20 is predicted to characterize the energy consumption in terms of energy consumed by the candidate target network node 14T and/or energy consumed by a wireless communication device 12.

In some embodiments, the information 20 is predicted to characterize radio configuration that the candidate target network node 14T would use to provide service to a wireless communication device 12 if the candidate target network node 14T were to be a target of the reconfiguration procedure 18. In some embodiments, the information 20 is predicted to characterize the radio configuration in terms of a multi-connectivity configuration or a carrier aggregation configuration.

In some embodiments, the information 20 is predicted to characterize radio resources used by service that the candidate target network node 14T would provide to a wireless communication device 12 if the candidate target network node 14T were to be a target of the reconfiguration procedure 18. In some embodiments, the information 20 is predicted to characterize the radio resources used in terms of physical resource blocks, PRBs, used

In some embodiments, the information 20 comprises, for each of one or more serving cells of the candidate target network node 14T, information 20 predicted to characterize service that the serving cell of the candidate target network node 14T would provide to a wireless communication device 12 if the serving cell of the candidate target network node 14T were to be a target of the reconfiguration procedure 18.

In some embodiments, the information 20 comprises, for each of one or more candidate device configurations, information 20 predicted to characterize service that the candidate target network node 14T would provide to a wireless communication device 12 configured with that candidate device configuration if the candidate target network node 14T were to be a target of the reconfiguration procedure 18.

In some embodiments, the information 20 comprises, for each of one or more types of services, information 20 predicted to characterize service of that type that the candidate target network node 14T would provide to a wireless communication device 12 if the candidate target network node 14T were to be a target of the reconfiguration procedure 18.

In some embodiments, receiving the information 20 comprises receiving a message that includes the information 20, wherein the message is a performance prediction update message that reports results of performance prediction performed at the candidate target network node 14T.

In some embodiments, the information 20 is received before execution of the reconfiguration procedure 18. In some embodiments, the method further comprises transmitting, to the candidate target network node 14T, a request 22 for the information 20 (Block 1500), and wherein the information 20 is received in response to the request 22. In some embodiments, the request 22 indicates one or more types of information requested that is predicted to characterize service that the candidate target network node 14T would provide to a wireless communication device 12 if the candidate target network node 14T were to be a target of the reconfiguration procedure 18. In some embodiments, the request 22 indicates one or more capabilities of the wireless communication device 12, results of one or more radio measurements of the wireless communication device 12, and/or a trajectory of the wireless communication device 12. In some embodiments, the request 22 indicates one or more cells for which the information 20 is requested, one or more types of services for which the information 20 is requested, and/or one or more candidate device configurations for which the information 20 is requested.

In some embodiments, the reconfiguration procedure 18 is a mobility procedure, a multi-connectivity procedure, a PSCell addition or change procedure, or a conditional reconfiguration procedure 18.

In some embodiments, the method further comprises making a decision based on the received information 20 (Block 1520). In some embodiments, the decision is a decision about whether the candidate target network node 14T is to be a target of the reconfiguration procedure 18 and/or a decision about which of one or more candidate target network nodes 14T is to be a target of the reconfiguration procedure 18. In some embodiments, the decision is a decision about whether the wireless communication device 12 is to perform the reconfiguration procedure 18. In some embodiments, the decision is a decision about how to configure one or more parameters governing mobility of, or traffic steering of, the wireless communication device 12. In some embodiments, the decision is based further on one or more measurements reported by the wireless communication device 12.

In some embodiments, the method further comprises initiating the reconfiguration procedure 18 based on the received information 20 (Block 1530).

In some embodiments, the information 20 comprises one or more metrics predicted to characterize service that the candidate target network node 14T would provide to a wireless communication device 12 if the candidate target network node 14T were to be a target of the reconfiguration procedure 18.

In some embodiments, the method further comprises relaying a measurement configuration from the candidate target network node 14T to the wireless communication device 12, and relaying results of measurements performed by the wireless communication device 12 according to the measurement configuration from the wireless communication device 12 to the candidate target network node 14T (Block 1505). In some embodiments, the information 20 is received after relaying the results to the candidate target network node 14T.

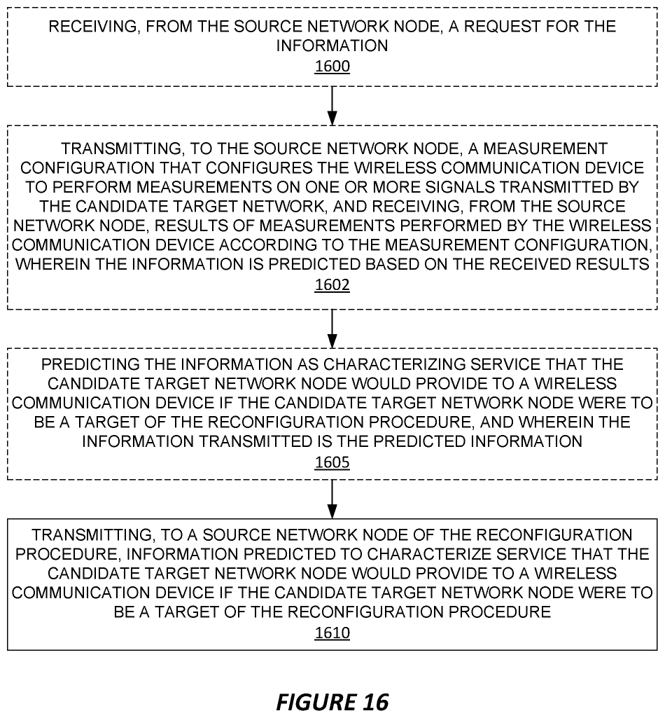

With reference to FIG. 3, FIG. 16 depicts a method performed by a network node configured to operate as a candidate target network node 14T of a reconfiguration procedure 18 in accordance with other particular embodiments. The method includes transmitting, to a source network node 14S of the reconfiguration procedure 18, information 20 predicted to characterize service that the candidate target network node 14T would provide to a wireless communication device 12 if the candidate target network node 14T were to be a target of the reconfiguration procedure 18 (Block 1610).

In some embodiments, the information 20 is predicted to characterize a performance of service that the candidate target network node 14T would provide to a wireless communication device 12 if the candidate target network node 14T were to be a target of the reconfiguration procedure 18.

In some embodiments, the information 20 is predicted to characterize the performance in terms of one or more of throughput, delay, jitter, packet error rate, block error rate, or traffic pattern. In some embodiments, the information 20 is predicted to characterize the performance at an application layer. In some embodiments, the information 20 is predicted to characterize the performance in terms of one or more radio signal measurements. In some embodiments, the information 20 is predicted to characterize the performance at a physical layer. In some embodiments, the information 20 indicates whether the performance of service, that the candidate target network node 14T would provide to a wireless communication device 12 if the candidate target network node 14T were to be a target of the reconfiguration procedure 18, is predicted to be above or below a specified threshold.

In some embodiments, the information 20 is predicted to characterize a duration of time for which the candidate target network node 14T would provide service to a wireless communication device 12 if the candidate target network node 14T were to be a target of the reconfiguration procedure 18. In some embodiments, the information 20 is predicted to characterize the duration of time in terms of a device dwelling time.

In some embodiments, the information 20 is predicted to characterize energy consumption attributable to service that the candidate target network node 14T would provide to a wireless communication device 12 if the candidate target network node 14T were to be a target of the reconfiguration procedure 18. In some embodiments, the information 20 is predicted to characterize the energy consumption in terms of energy consumed by the candidate target network node 14T and/or energy consumed by a wireless communication device 12.

In some embodiments, the information 20 is predicted to characterize radio configuration that the candidate target network node 14T would use to provide service to a wireless communication device 12 if the candidate target network node 14T were to be a target of the reconfiguration procedure 18. In some embodiments, the information 20 is predicted to characterize the radio configuration in terms of a multi-connectivity configuration or a carrier aggregation configuration.

In some embodiments, the information 20 is predicted to characterize radio resources used by service that the candidate target network node 14T would provide to a wireless communication device 12 if the candidate target network node 14T were to be a target of the reconfiguration procedure 18. In some embodiments, the information 20 is predicted to characterize the radio resources used in terms of physical resource blocks, PRBs, used.

In some embodiments, the information 20 comprises, for each of one or more serving cells of the candidate target network node 14T, information 20 predicted to characterize service that the serving cell of the candidate target network node 14T would provide to a wireless communication device 12 if the serving cell of the candidate target network node 14T were to be a target of the reconfiguration procedure 18.

In some embodiments, the information 20 comprises, for each of one or more candidate device configurations, information 20 predicted to characterize service that the candidate target network node 14T would provide to a wireless communication device 12 configured with that candidate device configuration if the candidate target network node 14T were to be a target of the reconfiguration procedure 18.

In some embodiments, the information 20 comprises, for each of one or more types of services, information 20 predicted to characterize service of that type that the candidate target network node 14T would provide to a wireless communication device 12 if the candidate target network node 14T were to be a target of the reconfiguration procedure 18.

In some embodiments, transmitting the information 20 comprises transmitting a message that includes the information 20, wherein the message is a performance prediction update message that reports results of performance prediction performed at the candidate target network node 14T.

In some embodiments, the information 20 is transmitted before execution of the reconfiguration procedure 18.

In some embodiments, the method further comprises receiving, from the source network node 14S, a request 22 for the information 20 (Block 1600). In some embodiments, the information 20 is transmitted in response to the request 22. In some embodiments, the request 22 indicates one or more types of information 20 requested that is predicted to characterize service that the candidate target network node 14T would provide to a wireless communication device 12 if the candidate target network node 14T were to be a target of the reconfiguration procedure 18. In some embodiments, the request 22 indicates one or more capabilities of the wireless communication device 12, results of one or more radio measurements of the wireless communication device 12, and/or a trajectory of the wireless communication device 12. In some embodiments, the request 22 indicates one or more cells for which the information 20 is requested, one or more types of services for which the information 20 is requested, and/or one or more candidate device configurations for which the information 20 is requested

In some embodiments, the reconfiguration procedure 18 is a mobility procedure, a multi-connectivity procedure, a PSCell addition or change procedure, or a conditional reconfiguration procedure 18.

In some embodiments, the method further comprises predicting the information 20 as characterizing service that the candidate target network node 14T would provide to a wireless communication device 12 if the candidate target network node 14T were to be a target of the reconfiguration procedure 18 (Block 1610), and wherein the information 20 transmitted is the predicted information 20. In some embodiments, the method further comprises training a model to predict the information 20, and predicting the information 20 using the model. In some embodiments, the method further comprises adapting the model based on observed characteristics of service that the candidate target network node 14T actually provides to a wireless communication device 12 after the candidate target network node 14T is a target of the reconfiguration procedure 18. In some embodiments, the model is a machine learning model.

In some embodiments, the method further comprises transmitting, to the source network node 14S, a measurement configuration that configures the wireless communication device 12 to perform measurements on one or more signals transmitted by the candidate target network, and receiving, from the source network node 14S, results of measurements performed by the wireless communication device 12 according to the measurement configuration, wherein the information 20 is predicted based on the received results (Block 1602).

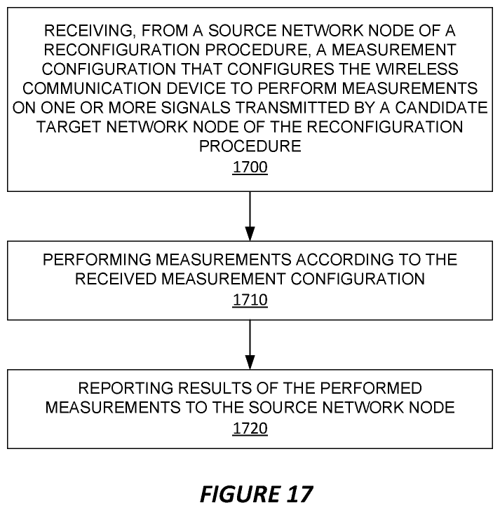

FIG. 17 depicts a method performed by a wireless communication device 12 in accordance with other particular embodiments. The method includes receiving, from a source network node 14S of a reconfiguration procedure 18, a measurement configuration that configures the wireless communication device 12 to perform measurements on one or more signals transmitted by a candidate target network node 14T of the reconfiguration procedure 18 (Block 1700). The method further comprises performing measurements according to the received measurement configuration (Block 1710). The method also comprises reporting results of the performed measurements to the source network node 14S (Block 1720).

Although the term predicting has been used in FIGS. 15-17, the prediction in other embodiments may be an estimate such that “predicting” may be exchangeable with the term “estimating”.

Embodiments herein also include corresponding apparatuses. Embodiments herein for instance include a wireless communication device 12 configured to perform any of the steps of any of the embodiments described above for the wireless communication device 12.

Embodiments also include a wireless communication device 12 comprising processing circuitry and power supply circuitry. The processing circuitry is configured to perform any of the steps of any of the embodiments described above for the wireless communication device 12. The power supply circuitry is configured to supply power to the wireless communication device 12.

Embodiments further include a wireless communication device 12 comprising processing circuitry. The processing circuitry is configured to perform any of the steps of any of the embodiments described above for the wireless communication device 12. In some embodiments, the wireless communication device 12 further comprises communication circuitry.

Embodiments further include a wireless communication device 12 comprising processing circuitry and memory. The memory contains instructions executable by the processing circuitry whereby the wireless communication device 12 is configured to perform any of the steps of any of the embodiments described above for the wireless communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node configured to perform any of the steps of any of the embodiments described above for the source network node 14S or the candidate target network node 14T.

Embodiments also include a network node comprising processing circuitry and power supply circuitry. The processing circuitry is configured to perform any of the steps of any of the embodiments described above for the source network node 14S or the candidate target network node 14T. The power supply circuitry is configured to supply power to the network node.

Embodiments further include a network node comprising processing circuitry. The processing circuitry is configured to perform any of the steps of any of the embodiments described above for the source network node 14S or the candidate target network node 14T. In some embodiments, the network node further comprises communication circuitry.

Embodiments further include a network node comprising processing circuitry and memory. The memory contains instructions executable by the processing circuitry whereby the network node is configured to perform any of the steps of any of the embodiments described above for the source network node 14S or the candidate target network node 14T.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

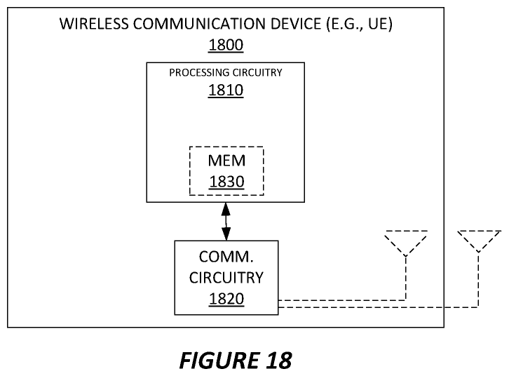

FIG. 18 for example illustrates a wireless communication device 1800 (e.g., wireless communication device 12) as implemented in accordance with one or more embodiments. As shown, the wireless communication device 1800 includes processing circuitry 1810 and communication circuitry 1820. The communication circuitry 1820 (e.g., radio circuitry) is configured to transmit and/or receive information to and/or from one or more other nodes, e.g., via any communication technology. Such communication may occur via one or more antennas that are either internal or external to the wireless communication device 1800. The processing circuitry 1810 is configured to perform processing described above, e.g., in FIG. 17, such as by executing instructions stored in memory 1830. The processing circuitry 1810 in this regard may implement certain functional means, units, or modules.

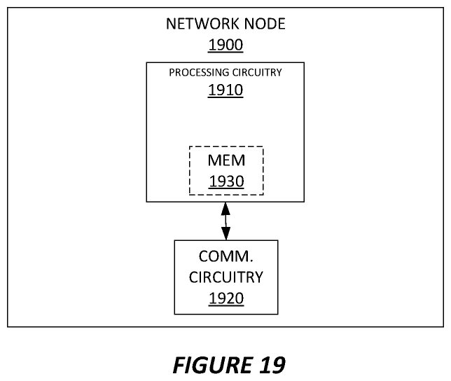

FIG. 19 illustrates a network node 1900 as implemented in accordance with one or more embodiments. The network node 1900 may be the source network node 14S or the candidate target network node 14T as described herein. As shown, the network node 1900 includes processing circuitry 1910 and communication circuitry 1920. The communication circuitry 1920 is configured to transmit and/or receive information to and/or from one or more other nodes, e.g., via any communication technology. The processing circuitry 1910 is configured to perform processing described above, e.g., in FIG. 15 or 16, such as by executing instructions stored in memory 1930. The processing circuitry 1910 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

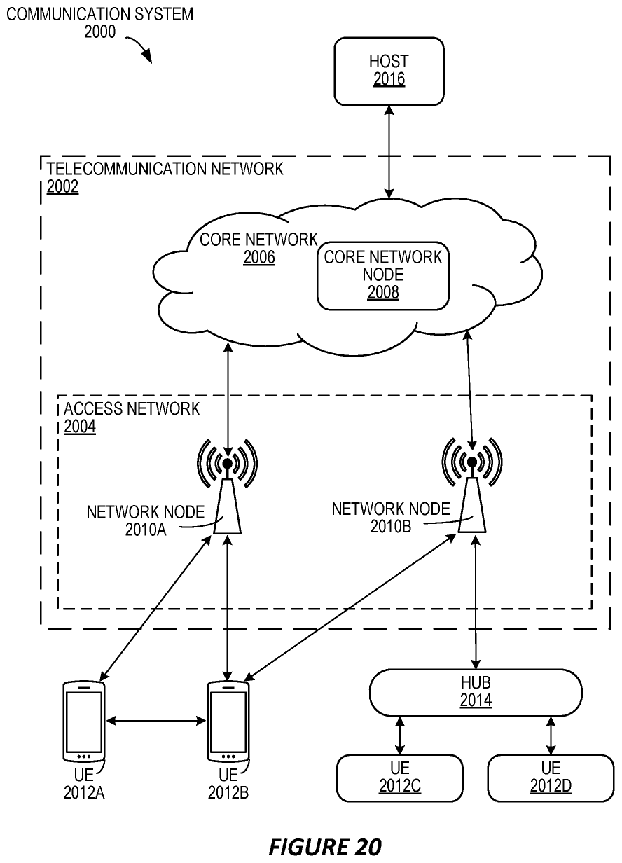

FIG. 20 shows an example of a communication system 2000 in accordance with some embodiments.

In the example, the communication system 2000 includes a telecommunication network 2002 that includes an access network 2004, such as a radio access network (RAN), and a core network 2006, which includes one or more core network nodes 2008. The access network 2004 includes one or more access network nodes, such as network nodes 2010a and 2010b (one or more of which may be generally referred to as network nodes 2010), or any other similar 3^{rd} Generation Partnership Project (3GPP) access node or non-3GPP access point. The network nodes 2010 facilitate direct or indirect connection of user equipment (UE), such as by connecting UEs 2012a, 2012b, 2012c, and 2012d (one or more of which may be generally referred to as UEs 2012) to the core network 2006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2000 may include any number of wired or wireless networks, network nodes, UEs, and/or any other components or systems that may facilitate or participate in the communication of data and/or signals whether via wired or wireless connections. The communication system 2000 may include and/or interface with any type of communication, telecommunication, data, cellular, radio network, and/or other similar type of system.

The UEs 2012 may be any of a wide variety of communication devices, including wireless devices arranged, configured, and/or operable to communicate wirelessly with the network nodes 2010 and other communication devices. Similarly, the network nodes 2010 are arranged, capable, configured, and/or operable to communicate directly or indirectly with the UEs 2012 and/or with other network nodes or equipment in the telecommunication network 2002 to enable and/or provide network access, such as wireless network access, and/or to perform other functions, such as administration in the telecommunication network 2002.

In the depicted example, the core network 2006 connects the network nodes 2010 to one or more hosts, such as host 2016. These connections may be direct or indirect via one or more intermediary networks or devices. In other examples, network nodes may be directly coupled to hosts. The core network 2006 includes one more core network nodes (e.g., core network node 2008) that are structured with hardware and software components. Features of these components may be substantially similar to those described with respect to the UEs, network nodes, and/or hosts, such that the descriptions thereof are generally applicable to the corresponding components of the core network node 2008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2016 may be under the ownership or control of a service provider other than an operator or provider of the access network 2004 and/or the telecommunication network 2002, and may be operated by the service provider or on behalf of the service provider. The host 2016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2000 of FIG. 20 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2002 is a cellular network that implements 3GPP standardized features. Accordingly, the telecommunications network 2002 may support network slicing to provide different logical networks to different devices that are connected to the telecommunication network 2002. For example, the telecommunications network 2002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2012 are configured to transmit and/or receive information without direct human interaction. For instance, a UE may be designed to transmit information to the access network 2004 on a predetermined schedule, when triggered by an internal or external event, or in response to requests from the access network 2004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 2014 communicates with the access network 2004 to facilitate indirect communication between one or more UEs (e.g., UE 2012c and/or 2012d) and network nodes (e.g., network node 2010b). In some examples, the hub 2014 may be a controller, router, content source and analytics, or any of the other communication devices described herein regarding UEs. For example, the hub 2014 may be a broadband router enabling access to the core network 2006 for the UEs. As another example, the hub 2014 may be a controller that sends commands or instructions to one or more actuators in the UEs. Commands or instructions may be received from the UEs, network nodes 2010, or by executable code, script, process, or other instructions in the hub 2014. As another example, the hub 2014 may be a data collector that acts as temporary storage for UE data and, in some embodiments, may perform analysis or other processing of the data. As another example, the hub 2014 may be a content source. For example, for a UE that is a VR headset, display, loudspeaker or other media delivery device, the hub 2014 may retrieve VR assets, video, audio, or other media or data related to sensory information via a network node, which the hub 2014 then provides to the UE either directly, after performing local processing, and/or after adding additional local content. In still another example, the hub 2014 acts as a proxy server or orchestrator for the UEs, in particular in if one or more of the UEs are low energy IoT devices.

The hub 2014 may have a constant/persistent or intermittent connection to the network node 2010b. The hub 2014 may also allow for a different communication scheme and/or schedule between the hub 2014 and UEs (e.g., UE 2012c and/or 2012d), and between the hub 2014 and the core network 2006. In other examples, the hub 2014 is connected to the core network 2006 and/or one or more UEs via a wired connection. Moreover, the hub 2014 may be configured to connect to an M2M service provider over the access network 2004 and/or to another UE over a direct connection. In some scenarios, UEs may establish a wireless connection with the network nodes 2010 while still connected via the hub 2014 via a wired or wireless connection. In some embodiments, the hub 2014 may be a dedicated hub—that is, a hub whose primary function is to route communications to/from the UEs from/to the network node 2010b. In other embodiments, the hub 2014 may be a non-dedicated hub—that is, a device which is capable of operating to route communications between the UEs and network node 2010b, but which is additionally capable of operating as a communication start and/or end point for certain data channels.

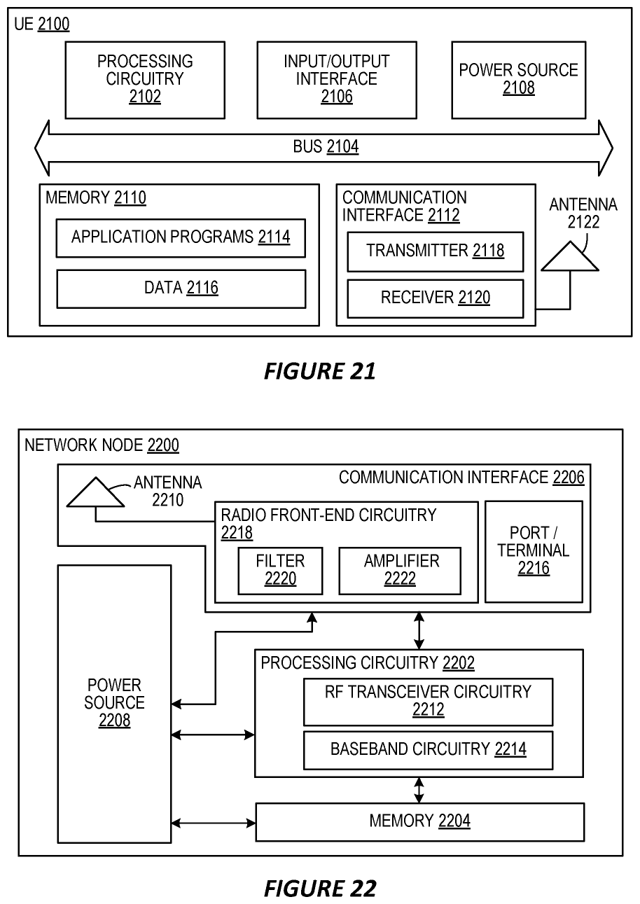

FIG. 21 shows a UE 2100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2100 includes processing circuitry 2102 that is operatively coupled via a bus 2104 to an input/output interface 2106, a power source 2108, a memory 2110, a communication interface 2112, and/or any other component, or any combination thereof. Certain UEs may utilize all or a subset of the components shown in FIG. 21. The level of integration between the components may vary from one UE to another UE. Further, certain UEs may contain multiple instances of a component, such as multiple processors, memories, transceivers, transmitters, receivers, etc.

The processing circuitry 2102 is configured to process instructions and data and may be configured to implement any sequential state machine operative to execute instructions stored as machine-readable computer programs in the memory 2110. The processing circuitry 2102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2102 may include multiple central processing units (CPUs).

In the example, the input/output interface 2106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2108 is structured as a battery or battery pack. Other types of power sources, such as an external power source (e.g., an electricity outlet), photovoltaic device, or power cell, may be used. The power source 2108 may further include power circuitry for delivering power from the power source 2108 itself, and/or an external power source, to the various parts of the UE 2100 via input circuitry or an interface such as an electrical power cable. Delivering power may be, for example, for charging of the power source 2108. Power circuitry may perform any formatting, converting, or other modification to the power from the power source 2108 to make the power suitable for the respective components of the UE 2100 to which power is supplied.

The memory 2110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2110 includes one or more application programs 2114, such as an operating system, web browser application, a widget, gadget engine, or other application, and corresponding data 2116. The memory 2110 may store, for use by the UE 2100, any of a variety of various operating systems or combinations of operating systems.

The memory 2110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2110 may allow the UE 2100 to access instructions, application programs and the like, stored on transitory or non-transitory memory media, to off-load data, or to upload data. An article of manufacture, such as one utilizing a communication system may be tangibly embodied as or in the memory 2110, which may be or comprise a device-readable storage medium.

The processing circuitry 2102 may be configured to communicate with an access network or other network using the communication interface 2112. The communication interface 2112 may comprise one or more communication subsystems and may include or be communicatively coupled to an antenna 2122. The communication interface 2112 may include one or more transceivers used to communicate, such as by communicating with one or more remote transceivers of another device capable of wireless communication (e.g., another UE or a network node in an access network). Each transceiver may include a transmitter 2118 and/or a receiver 2120 appropriate to provide network communications (e.g., optical, electrical, frequency allocations, and so forth). Moreover, the transmitter 2118 and receiver 2120 may be coupled to one or more antennas (e.g., antenna 2122) and may share circuit components, software or firmware, or alternatively be implemented separately.

In the illustrated embodiment, communication functions of the communication interface 2112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2100 shown in FIG. 21.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 22 shows a network node 2200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2200 includes a processing circuitry 2202, a memory 2204, a communication interface 2206, and a power source 2208. The network node 2200 may be composed of multiple physically separate components (e.g., a NodeB component and a RNC component, or a BTS component and a BSC component, etc.), which may each have their own respective components. In certain scenarios in which the network node 2200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2200 may be configured to support multiple radio access technologies (RATs). In such embodiments, some components may be duplicated (e.g., separate memory 2204 for different RATs) and some components may be reused (e.g., a same antenna 2210 may be shared by different RATs). The network node 2200 may also include multiple sets of the various illustrated components for different wireless technologies integrated into network node 2200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2200.

The processing circuitry 2202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2200 components, such as the memory 2204, to provide network node 2200 functionality.

In some embodiments, the processing circuitry 2202 includes a system on a chip (SOC). In some embodiments, the processing circuitry 2202 includes one or more of radio frequency (RF) transceiver circuitry 2212 and baseband processing circuitry 2214. In some embodiments, the radio frequency (RF) transceiver circuitry 2212 and the baseband processing circuitry 2214 may be on separate chips (or sets of chips), boards, or units, such as radio units and digital units. In alternative embodiments, part or all of RF transceiver circuitry 2212 and baseband processing circuitry 2214 may be on the same chip or set of chips, boards, or units.

The memory 2204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2202. The memory 2204 may store any suitable instructions, data, or information, including a computer program, software, an application including one or more of logic, rules, code, tables, and/or other instructions capable of being executed by the processing circuitry 2202 and utilized by the network node 2200. The memory 2204 may be used to store any calculations made by the processing circuitry 2202 and/or any data received via the communication interface 2206. In some embodiments, the processing circuitry 2202 and memory 2204 is integrated.

The communication interface 2206 is used in wired or wireless communication of signaling and/or data between a network node, access network, and/or UE. As illustrated, the communication interface 2206 comprises port(s)/terminal(s) 2216 to send and receive data, for example to and from a network over a wired connection. The communication interface 2206 also includes radio front-end circuitry 2218 that may be coupled to, or in certain embodiments a part of, the antenna 2210. Radio front-end circuitry 2218 comprises filters 2220 and amplifiers 2222.

The radio front-end circuitry 2218 may be connected to an antenna 2210 and processing circuitry 2202. The radio front-end circuitry may be configured to condition signals communicated between antenna 2210 and processing circuitry 2202. The radio front-end circuitry 2218 may receive digital data that is to be sent out to other network nodes or UEs via a wireless connection. The radio front-end circuitry 2218 may convert the digital data into a radio signal having the appropriate channel and bandwidth parameters using a combination of filters 2220 and/or amplifiers 2222. The radio signal may then be transmitted via the antenna 2210. Similarly, when receiving data, the antenna 2210 may collect radio signals which are then converted into digital data by the radio front-end circuitry 2218. The digital data may be passed to the processing circuitry 2202. In other embodiments, the communication interface may comprise different components and/or different combinations of components.

In certain alternative embodiments, the network node 2200 does not include separate radio front-end circuitry 2218, instead, the processing circuitry 2202 includes radio front-end circuitry and is connected to the antenna 2210. Similarly, in some embodiments, all or some of the RF transceiver circuitry 2212 is part of the communication interface 2206. In still other embodiments, the communication interface 2206 includes one or more ports or terminals 2216, the radio front-end circuitry 2218, and the RF transceiver circuitry 2212, as part of a radio unit (not shown), and the communication interface 2206 communicates with the baseband processing circuitry 2214, which is part of a digital unit (not shown).

The antenna 2210 may include one or more antennas, or antenna arrays, configured to send and/or receive wireless signals. The antenna 2210 may be coupled to the radio front-end circuitry 2218 and may be any type of antenna capable of transmitting and receiving data and/or signals wirelessly. In certain embodiments, the antenna 2210 is separate from the network node 2200 and connectable to the network node 2200 through an interface or port.

The antenna 2210, communication interface 2206, and/or the processing circuitry 2202 may be configured to perform any receiving operations and/or certain obtaining operations described herein as being performed by the network node. Any information, data and/or signals may be received from a UE, another network node and/or any other network equipment. Similarly, the antenna 2210, the communication interface 2206, and/or the processing circuitry 2202 may be configured to perform any transmitting operations described herein as being performed by the network node. Any information, data and/or signals may be transmitted to a UE, another network node and/or any other network equipment.

The power source 2208 provides power to the various components of network node 2200 in a form suitable for the respective components (e.g., at a voltage and current level needed for each respective component). The power source 2208 may further comprise, or be coupled to, power management circuitry to supply the components of the network node 2200 with power for performing the functionality described herein. For example, the network node 2200 may be connectable to an external power source (e.g., the power grid, an electricity outlet) via an input circuitry or interface such as an electrical cable, whereby the external power source supplies power to power circuitry of the power source 2208. As a further example, the power source 2208 may comprise a source of power in the form of a battery or battery pack which is connected to, or integrated in, power circuitry. The battery may provide backup power should the external power source fail.

Embodiments of the network node 2200 may include additional components beyond those shown in FIG. 22 for providing certain aspects of the network node's functionality, including any of the functionality described herein and/or any functionality necessary to support the subject matter described herein. For example, the network node 2200 may include user interface equipment to allow input of information into the network node 2200 and to allow output of information from the network node 2200. This may allow a user to perform diagnostic, maintenance, repair, and other administrative functions for the network node 2200.

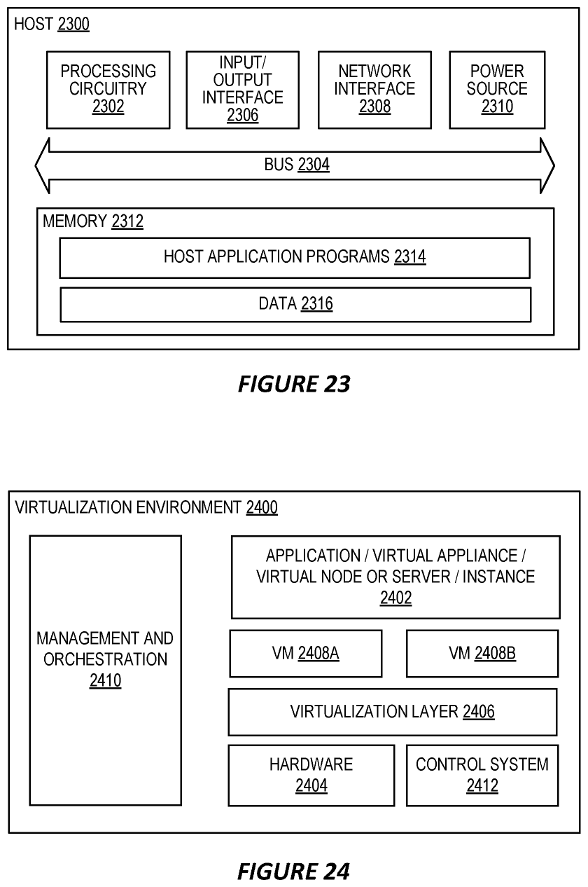

FIG. 23 is a block diagram of a host 2300, which may be an embodiment of the host 2016 of FIG. 20, in accordance with various aspects described herein. As used herein, the host 2300 may be or comprise various combinations hardware and/or software, including a standalone server, a blade server, a cloud-implemented server, a distributed server, a virtual machine, container, or processing resources in a server farm. The host 2300 may provide one or more services to one or more UEs.

The host 2300 includes processing circuitry 2302 that is operatively coupled via a bus 2304 to an input/output interface 2306, a network interface 2308, a power source 2310, and a memory 2312. Other components may be included in other embodiments. Features of these components may be substantially similar to those described with respect to the devices of previous figures, such as FIGS. 21 and 22, such that the descriptions thereof are generally applicable to the corresponding components of host 2300.

The memory 2312 may include one or more computer programs including one or more host application programs 2314 and data 2316, which may include user data, e.g., data generated by a UE for the host 2300 or data generated by the host 2300 for a UE. Embodiments of the host 2300 may utilize only a subset or all of the components shown. The host application programs 2314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2314 may also provide for user authentication and licensing checks and may periodically report health, routes, and content availability to a central node, such as a device in or on the edge of a core network. Accordingly, the host 2300 may select and/or indicate a different host for over-the-top services for a UE. The host application programs 2314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 24 is a block diagram illustrating a virtualization environment 2400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2406 (also referred to as hypervisors or virtual machine monitors (VMMs), provide VMs 2408a and 2408b (one or more of which may be generally referred to as VMs 2408), and/or perform any of the functions, features and/or benefits described in relation with some embodiments described herein. The virtualization layer 2406 may present a virtual operating platform that appears like networking hardware to the VMs 2408.

The VMs 2408 comprise virtual processing, virtual memory, virtual networking or interface and virtual storage, and may be run by a corresponding virtualization layer 2406. Different embodiments of the instance of a virtual appliance 2402 may be implemented on one or more of VMs 2408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2408 may be a software implementation of a physical machine that runs programs as if they were executing on a physical, non-virtualized machine. Each of the VMs 2408, and that part of hardware 2404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2408 on top of the hardware 2404 and corresponds to the application 2402.

Hardware 2404 may be implemented in a standalone network node with generic or specific components. Hardware 2404 may implement some functions via virtualization. Alternatively, hardware 2404 may be part of a larger cluster of hardware (e.g. such as in a data center or CPE) where many hardware nodes work together and are managed via management and orchestration 2410, which, among others, oversees lifecycle management of applications 2402. In some embodiments, hardware 2404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2412 which may alternatively be used for communication between hardware nodes and radio units.

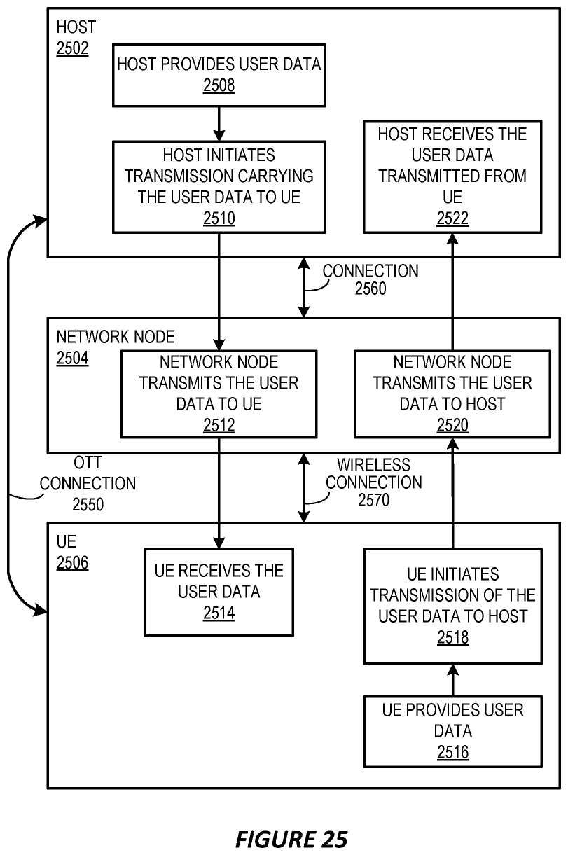

FIG. 25 shows a communication diagram of a host 2502 communicating via a network node 2504 with a UE 2506 over a partially wireless connection in accordance with some embodiments. Example implementations, in accordance with various embodiments, of the UE (such as a UE 2012a of FIG. 20 and/or UE 2100 of FIG. 21), network node (such as network node 2010a of FIG. 20 and/or network node 2200 of FIG. 22), and host (such as host 2016 of FIG. 20 and/or host 2300 of FIG. 23) discussed in the preceding paragraphs will now be described with reference to FIG. 25.

Like host 2300, embodiments of host 2502 include hardware, such as a communication interface, processing circuitry, and memory. The host 2502 also includes software, which is stored in or accessible by the host 2502 and executable by the processing circuitry. The software includes a host application that may be operable to provide a service to a remote user, such as the UE 2506 connecting via an over-the-top (OTT) connection 2550 extending between the UE 2506 and host 2502. In providing the service to the remote user, a host application may provide user data which is transmitted using the OTT connection 2550.

The network node 2504 includes hardware enabling it to communicate with the host 2502 and UE 2506. The connection 2560 may be direct or pass through a core network (like core network 2006 of FIG. 20) and/or one or more other intermediate networks, such as one or more public, private, or hosted networks. For example, an intermediate network may be a backbone network or the Internet.

The UE 2506 includes hardware and software, which is stored in or accessible by UE 2506 and executable by the UE's processing circuitry. The software includes a client application, such as a web browser or operator-specific “app” that may be operable to provide a service to a human or non-human user via UE 2506 with the support of the host 2502. In the host 2502, an executing host application may communicate with the executing client application via the OTT connection 2550 terminating at the UE 2506 and host 2502. In providing the service to the user, the UE's client application may receive request data from the host's host application and provide user data in response to the request data. The OTT connection 2550 may transfer both the request data and the user data. The UE's client application may interact with the user to generate the user data that it provides to the host application through the OTT connection 2550.

The OTT connection 2550 may extend via a connection 2560 between the host 2502 and the network node 2504 and via a wireless connection 2570 between the network node 2504 and the UE 2506 to provide the connection between the host 2502 and the UE 2506. The connection 2560 and wireless connection 2570, over which the OTT connection 2550 may be provided, have been drawn abstractly to illustrate the communication between the host 2502 and the UE 2506 via the network node 2504, without explicit reference to any intermediary devices and the precise routing of messages via these devices.

As an example of transmitting data via the OTT connection 2550, in step 2508, the host 2502 provides user data, which may be performed by executing a host application. In some embodiments, the user data is associated with a particular human user interacting with the UE 2506. In other embodiments, the user data is associated with a UE 2506 that shares data with the host 2502 without explicit human interaction. In step 2510, the host 2502 initiates a transmission carrying the user data towards the UE 2506. The host 2502 may initiate the transmission responsive to a request transmitted by the UE 2506. The request may be caused by human interaction with the UE 2506 or by operation of the client application executing on the UE 2506. The transmission may pass via the network node 2504, in accordance with the teachings of the embodiments described throughout this disclosure. Accordingly, in step 2512, the network node 2504 transmits to the UE 2506 the user data that was carried in the transmission that the host 2502 initiated, in accordance with the teachings of the embodiments described throughout this disclosure. In step 2514, the UE 2506 receives the user data carried in the transmission, which may be performed by a client application executed on the UE 2506 associated with the host application executed by the host 2502.

In some examples, the UE 2506 executes a client application which provides user data to the host 2502. The user data may be provided in reaction or response to the data received from the host 2502. Accordingly, in step 2516, the UE 2506 may provide user data, which may be performed by executing the client application. In providing the user data, the client application may further consider user input received from the user via an input/output interface of the UE 2506. Regardless of the specific manner in which the user data was provided, the UE 2506 initiates, in step 2518, transmission of the user data towards the host 2502 via the network node 2504. In step 2520, in accordance with the teachings of the embodiments described throughout this disclosure, the network node 2504 receives user data from the UE 2506 and initiates transmission of the received user data towards the host 2502. In step 2522, the host 2502 receives the user data carried in the transmission initiated by the UE 2506.

One or more of the various embodiments improve the performance of OTT services provided to the UE 2506 using the OTT connection 2550, in which the wireless connection 2570 forms the last segment.

In an example scenario, factory status information may be collected and analyzed by the host 2502. As another example, the host 2502 may process audio and video data which may have been retrieved from a UE for use in creating maps. As another example, the host 2502 may collect and analyze real-time data to assist in controlling vehicle congestion (e.g., controlling traffic lights). As another example, the host 2502 may store surveillance video uploaded by a UE. As another example, the host 2502 may store or control access to media content such as video, audio, VR or AR which it can broadcast, multicast or unicast to UEs. As other examples, the host 2502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2550 between the host 2502 and UE 2506, in response to variations in the measurement results. The measurement procedure and/or the network functionality for reconfiguring the OTT connection may be implemented in software and hardware of the host 2502 and/or UE 2506. In some embodiments, sensors (not shown) may be deployed in or in association with other devices through which the OTT connection 2550 passes; the sensors may participate in the measurement procedure by supplying values of the monitored quantities exemplified above, or supplying values of other physical quantities from which software may compute or estimate the monitored quantities. The reconfiguring of the OTT connection 2550 may include message format, retransmission settings, preferred routing etc.; the reconfiguring need not directly alter the operation of the network node 2504. Such procedures and functionalities may be known and practiced in the art. In certain embodiments, measurements may involve proprietary UE signaling that facilitates measurements of throughput, propagation times, latency and the like, by the host 2502. The measurements may be implemented in that software causes messages to be transmitted, in particular empty or ‘dummy’ messages, using the OTT connection 2550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a wireless communication device, the method comprising:
receiving, from a source network node of a reconfiguration procedure, a measurement configuration that configures the wireless communication device to perform measurements on one or more signals transmitted by a candidate target network node of the reconfiguration procedure;
performing measurements according to the received measurement configuration; and reporting results of the performed measurements to the source network node.

A2. The method of embodiment A1, wherein the reconfiguration procedure is a mobility procedure, a multi-connectivity procedure, a PSCell addition or change procedure, or a conditional reconfiguration procedure.

AA1. A method performed by a wireless terminal (so-called a User Equipment), the method comprising: receiving from a first network node prior to a reconfiguration procedure, a measurement configuration including measurement objects and report config pertain to the cells belonging to the second RAN nodes or the other neighbouring RAN nodes;
performing the measurement according to the configuration;
sending the measurement report associated to the measurement configuration compiled and sent by the second RAN node to the first network node.

### Group B Embodiments

B1. A method performed by a network node configured to operate as a source network node of a reconfiguration procedure, the method comprising:
receiving, from a candidate target network node of the reconfiguration procedure, information predicted to characterize service that the candidate target network node would provide to a wireless communication device if the candidate target network node were to be a target of the reconfiguration procedure.

B2. The method of embodiment B1, wherein the information is predicted to characterize a performance of service that the candidate target network node would provide to a wireless communication device if the candidate target network node were to be a target of the reconfiguration procedure.

B3. The method of embodiment B2, wherein the information is predicted to characterize the performance in terms of one or more of:
throughput;
delay;
jitter;
packet error rate;
block error rate; or traffic pattern.

B4. The method of any of embodiments B2-B3, wherein the information is predicted to characterize the performance at an application layer.

B5. The method of any of embodiments B2-B4, wherein the information is predicted to characterize the performance in terms of one or more radio signal measurements.

B6. The method of any of embodiments B2-B5, wherein the information is predicted to characterize the performance at a physical layer.

B7. The method of any of embodiments B2-B6, wherein the information indicates whether the performance of service, that the candidate target network node would provide to a wireless communication device if the candidate target network node were to be a target of the reconfiguration procedure, is predicted to be above or below a specified threshold.

B8. The method of any of embodiments B1-B7, wherein the information is predicted to characterize a duration of time for which the candidate target network node would provide service to a wireless communication device if the candidate target network node were to be a target of the reconfiguration procedure.

B9. The method of embodiment B8, wherein the information is predicted to characterize the duration of time in terms of a device dwelling time in the candidate target network node.

B10. The method of any of embodiments B1-B9, wherein the information is predicted to characterize energy consumption attributable to service that the candidate target network node would provide to a wireless communication device if the candidate target network node were to be a target of the reconfiguration procedure.

B11. The method of embodiment B10, wherein the information is predicted to characterize the energy consumption in terms of energy consumed by the candidate target network node and/or energy consumed by a wireless communication device.

B12. The method of any of embodiments B1-B11, wherein the information is predicted to characterize radio configuration that the candidate target network node would use to provide service to a wireless communication device if the candidate target network node were to be a target of the reconfiguration procedure.

B13. The method of embodiment B12, wherein the information is predicted to characterize the radio configuration in terms of a multi-connectivity configuration or a carrier aggregation configuration.

B14. The method of any of embodiments B1-B13, wherein the information is predicted to characterize radio resources used by service that the candidate target network node would provide to a wireless communication device if the candidate target network node were to be a target of the reconfiguration procedure.

B15. The method of embodiment B14, wherein the information is predicted to characterize the radio resources used in terms of physical resource blocks, PRBs, used.

B16. The method of any of embodiments B1-B15, wherein the information comprises, for each of one or more serving cells of the candidate target network node, information predicted to characterize service that the serving cell of the candidate target network node would provide to a wireless communication device if the serving cell of the candidate target network node were to be a target of the reconfiguration procedure.

B17. The method of any of embodiments B1-B16, wherein the information comprises, for each of one or more candidate device configurations, information predicted to characterize service that the candidate target network node would provide to a wireless communication device configured with that candidate device configuration if the candidate target network node were to be a target of the reconfiguration procedure.

B18. The method of any of embodiments B1-B17, wherein the information comprises, for each of one or more types of services, information predicted to characterize service of that type that the candidate target network node would provide to a wireless communication device if the candidate target network node were to be a target of the reconfiguration procedure.

B19. The method of any of embodiments B1-B18, wherein receiving the information comprises receiving a message that includes the information, wherein the message is a performance prediction update message that reports results of performance prediction performed at the candidate target network node.

B20. The method of any of embodiments B1-B19, wherein the information is received before execution of the reconfiguration procedure.

B21. The method of any of embodiments B1-B20, further comprising transmitting, to the candidate target network node, a request for the information, and wherein the information is received in response to the request.

B22. The method of embodiment B21, wherein the request indicates one or more types of information requested that is predicted to characterize service that the candidate target network node would provide to a wireless communication device if the candidate target network node were to be a target of the reconfiguration procedure.

B23. The method of any of embodiments B21-B22, wherein the request indicates one or more capabilities of the wireless communication device, results of one or more radio measurements of the wireless communication device, and/or a trajectory of the wireless communication device.

B24. The method of any of embodiments B21-B23, wherein the request indicates one or more cells for which the information is requested, one or more types of services for which the information is requested, and/or one or more candidate device configurations for which the information is requested.

B25. The method of any of embodiments B1-B24, wherein the reconfiguration procedure is a mobility procedure, a multi-connectivity procedure, a PSCell addition or change procedure, or a conditional reconfiguration procedure.

B26. The method of any of embodiments B1-B25, further comprising making a decision based on the received information.

B27. The method of embodiment B26, wherein the decision is a decision about whether the candidate target network node is to be a target of the reconfiguration procedure and/or a decision about which of one or more candidate target network nodes is to be a target of the reconfiguration procedure.

B28. The method of embodiment B26, wherein the decision is a decision about whether the wireless communication device is to perform the reconfiguration procedure.

B29. The method of embodiment B26, wherein the decision is a decision about how to configure one or more parameters governing mobility of, or traffic steering of, the wireless communication device.

B30. The method of any of embodiments B26-B29, wherein the decision is based further on one or more measurements reported by the wireless communication device.

B31. The method of any of embodiments B1-B30, further comprising initiating the reconfiguration procedure based on the received information.

B32. The method of any of embodiments B1-B31, wherein the information comprises one or more metrics predicted to characterize service that the candidate target network node would provide to a wireless communication device if the candidate target network node were to be a target of the reconfiguration procedure.

B33. The method of any of embodiments B1-B32, further comprising relaying a measurement configuration from the candidate target network node to the wireless communication device, and relaying results of measurements performed by the wireless communication device according to the measurement configuration from the wireless communication device to the candidate target network node, wherein the information is received after relaying the results to the candidate target network node.

BB1. A method performed by a network node configured to operate as a candidate target network node of a reconfiguration procedure, the method comprising:

transmitting, to a source network node of the reconfiguration procedure, information predicted to characterize service that the candidate target network node would provide to a wireless communication device if the candidate target network node were to be a target of the reconfiguration procedure.

BB2. The method of embodiment BB1, wherein the information is predicted to characterize a performance of service that the candidate target network node would provide to a wireless communication device if the candidate target network node were to be a target of the reconfiguration procedure.

BB3. The method of embodiment BB2, wherein the information is predicted to characterize the performance in terms of one or more of:
throughput;
delay;
jitter;
packet error rate;
block error rate; or traffic pattern.

BB4. The method of any of embodiments BB2-BB3, wherein the information is predicted to characterize the performance at an application layer.

BB5. The method of any of embodiments BB2-BB4, wherein the information is predicted to characterize the performance in terms of one or more radio signal measurements.

BB6. The method of any of embodiments BB2-BB5, wherein the information is predicted to characterize the performance at a physical layer.

BB7. The method of any of embodiments BB2-BB6, wherein the information indicates whether the performance of service, that the candidate target network node would provide to a wireless communication device if the candidate target network node were to be a target of the reconfiguration procedure, is predicted to be above or below a specified threshold.

BB8. The method of any of embodiments BB1-BB7, wherein the information is predicted to characterize a duration of time for which the candidate target network node would provide service to a wireless communication device if the candidate target network node were to be a target of the reconfiguration procedure.

BB9. The method of embodiment BB8, wherein the information is predicted to characterize the duration of time in terms of a device dwelling time.

BB10. The method of any of embodiments BB1-BB9, wherein the information is predicted to characterize energy consumption attributable to service that the candidate target network node would provide to a wireless communication device if the candidate target network node were to be a target of the reconfiguration procedure.

BB11. The method of embodiment BB10, wherein the information is predicted to characterize the energy consumption in terms of energy consumed by the candidate target network node and/or energy consumed by a wireless communication device.

BB12. The method of any of embodiments BB1-BB11, wherein the information is predicted to characterize radio configuration that the candidate target network node would use to provide service to a wireless communication device if the candidate target network node were to be a target of the reconfiguration procedure.

BB13. The method of embodiment BB12, wherein the information is predicted to characterize the radio configuration in terms of a multi-connectivity configuration or a carrier aggregation configuration.

BB14. The method of any of embodiments BB1-BB13, wherein the information is predicted to characterize radio resources used by service that the candidate target network node would provide to a wireless communication device if the candidate target network node were to be a target of the reconfiguration procedure.

BB15. The method of embodiment BB14, wherein the information is predicted to characterize the radio resources used in terms of physical resource blocks, PRBs, used.

BB16. The method of any of embodiments BB1-BB15, wherein the information comprises, for each of one or more serving cells of the candidate target network node, information predicted to characterize service that the serving cell of the candidate target network node would provide to a wireless communication device if the serving cell of the candidate target network node were to be a target of the reconfiguration procedure.

BB17. The method of any of embodiments BB1-BB16, wherein the information comprises, for each of one or more candidate device configurations, information predicted to characterize service that the candidate target network node would provide to a wireless communication device configured with that candidate device configuration if the candidate target network node were to be a target of the reconfiguration procedure.

BB18. The method of any of embodiments BB1-BB17, wherein the information comprises, for each of one or more types of services, information predicted to characterize service of that type that the candidate target network node would provide to a wireless communication device if the candidate target network node were to be a target of the reconfiguration procedure.

BB19. The method of any of embodiments BB1-BB18, wherein transmitting the information comprises transmitting a message that includes the information, wherein the message is a performance prediction update message that reports results of performance prediction performed at the candidate target network node.

BB20. The method of any of embodiments BB1-BB19, wherein the information is transmitted before execution of the reconfiguration procedure.

BB21. The method of any of embodiments BB1-BB20, further comprising receiving, from the source network node, a request for the information, and wherein the information is transmitted in response to the request.

BB22. The method of embodiment BB21, wherein the request indicates one or more types of information requested that is predicted to characterize service that the candidate target network node would provide to a wireless communication device if the candidate target network node were to be a target of the reconfiguration procedure.

BB23. The method of any of embodiments BB21-BB22, wherein the request indicates one or more capabilities of the wireless communication device, results of one or more radio measurements of the wireless communication device, and/or a trajectory of the wireless communication device.

BB24. The method of any of embodiments BB21-BB23, wherein the request indicates one or more cells for which the information is requested, one or more types of services for which the information is requested, and/or one or more candidate device configurations for which the information is requested.

BB25. The method of any of embodiments BB1-BB24, wherein the reconfiguration procedure is a mobility procedure, a multi-connectivity procedure, a PSCell addition or change procedure, or a conditional reconfiguration procedure.

BB26. The method of any of embodiments BB1-BB25, further comprising predicting the information as characterizing service that the candidate target network node would provide to a wireless communication device if the candidate target network node were to be a target of the reconfiguration procedure, and wherein the information transmitted is the predicted information.

BB27. The method of embodiment BB26, further comprising:
training a model to predict the information; and
predicting the information using the model.

BB28. The method of embodiment BB27, further comprising adapting the model based on observed characteristics of service that the candidate target network node actually provides to a wireless communication device after the candidate target network node is a target of the reconfiguration procedure.

BB29. The method of any of embodiments BB27-BB28, wherein the model is a machine learning model.

BB30. The method of any of embodiments BB1-BB29, further comprising transmitting, to the source network node, a measurement configuration that configures the wireless communication device to perform measurements on one or more signals transmitted by the candidate target network, and receiving, from the source network node, results of measurements performed by the wireless communication device according to the measurement configuration, wherein the information is predicted based on the received results.

BBB1. A method performed by a first network node configured to operate as a source network node of a reconfiguration procedure for User Equipment (UE) mobility procedure or a dual connectivity procedure, the method comprising:
transmitting, to a second network node, prior to the reconfiguration procedure, signaling that request the second network node to provide UE performance estimation/prediction information to the first network node and optionally which one or more types of UE performance estimation/prediction information the second network node is to provide to the source network node;
receiving, from a second network node, prior to the reconfiguration procedure, signaling that indicates the UE performance estimation/prediction information for one or more types of UE performance estimation/prediction information based on the UE performance estimation/prediction information requested by the first network node;
determining the mobility decision, by taking into account the UE performance estimation/prediction information received from the second RAN node;
initiating the reconfiguration procedure toward a cell belonging to the second RAN node.

BBB2. A method performed by a second network node configured to operate as a target network node of a reconfiguration procedure for User Equipment (UE) mobility procedure or a dual connectivity procedure, the method comprising:
receiving, from a first network node, prior to the reconfiguration procedure, signaling that request the second network node to provide UE performance estimation/prediction information to the first network node and optionally which one or more types of UE performance estimation/prediction information the second network node is to provide to the source network node;
transmitting, to a first network node, prior to the reconfiguration procedure to be initiated by the first network node, signaling that indicates the UE performance estimation/prediction information for one or more types of UE performance estimation/prediction information based on the UE performance estimation/prediction information requested by the first network node.

BBB3. The method of embodiment BBB2, wherein, upon receiving a UE performance estimation/prediction information, the second network node:
compiles a request including a measurement configuration:
sends the measurement configuration to the first network node, and
requests the first network node to configure at least one UE to perform the requested measurements by the second network node.

### Group C Embodiments

C1. A wireless communication device configured to perform any of the steps of any of the Group A embodiments.

C2. A wireless communication device comprising processing circuitry configured to perform any of the steps of any of the Group A embodiments.

C3. A wireless communication device comprising:
communication circuitry; and
processing circuitry configured to perform any of the steps of any of the Group A embodiments.

C4. A wireless communication device comprising:
processing circuitry configured to perform any of the steps of any of the Group A embodiments; and power supply circuitry configured to supply power to the wireless communication device.

C5. A wireless communication device comprising:
processing circuitry and memory, the memory containing instructions executable by the processing circuitry whereby the wireless communication device is configured to perform any of the steps of any of the Group A embodiments.

C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C7. A computer program comprising instructions which, when executed by at least one processor of a wireless communication device, causes the wireless communication device to carry out the steps of any of the Group A embodiments.

C8. A carrier containing the computer program of embodiment C7, wherein the carrier is one of an electronic signal, optical signal, radio signal, or computer readable storage medium.

C9. A network node configured to perform any of the steps of any of the Group B embodiments.

C10. A network node comprising processing circuitry configured to perform any of the steps of any of the Group B embodiments.

C11. A network node comprising:
communication circuitry; and
processing circuitry configured to perform any of the steps of any of the Group B embodiments.

C12. A network node comprising:
processing circuitry configured to perform any of the steps of any of the Group B embodiments;
power supply circuitry configured to supply power to the network node.

C13. A network node comprising:
processing circuitry and memory, the memory containing instructions executable by the processing circuitry whereby the network node is configured to perform any of the steps of any of the Group B embodiments.

C14. The network node of any of embodiments C9-C13, wherein the network node is a base station.

C15. A computer program comprising instructions which, when executed by at least one processor of a network node, causes the network node to carry out the steps of any of the Group B embodiments.

C16. The computer program of embodiment C14, wherein the network node is a base station.

C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein:
the processing circuitry of the host computer is configured to execute a host application, thereby providing the user data; and the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D10. The communication system of the previous embodiment, wherein the cellular network further includes a base station configured to communicate with the UE.

D11. The communication system of the previous 2 embodiments, wherein:
the processing circuitry of the host computer is configured to execute a host application, thereby providing the user data; and
the UE's processing circuitry is configured to execute a client application associated with the host application.

D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

D13. The method of the previous embodiment, further comprising at the UE, receiving the user data from the base station.

D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein:
the processing circuitry of the host computer is configured to execute a host application; and
the UE's processing circuitry is configured to execute a client application associated with the host application, thereby providing the user data.

D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

D19. A method implemented in a communication system including a host computer, a base station and a user equipment (UE), the method comprising:
at the host computer, receiving user data transmitted to the base station from the UE, wherein the UE performs any of the steps of any of the Group A embodiments.

D20 The method of the previous embodiment, further comprising, at the UE, providing the user data to the base station.

D21. The method of the previous 2 embodiments, further comprising:
at the UE, executing a client application, thereby providing the user data to be transmitted; and
at the host computer, executing a host application associated with the client application.

D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein:
the processing circuitry of the host computer is configured to execute a host application;
the UE is configured to execute a client application associated with the host application, thereby providing the user data to be received by the host computer.

D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

D28. The method of the previous embodiment, further comprising at the base station, receiving the user data from the UE.

D29. The method of the previous 2 embodiments, further comprising at the base station, initiating a transmission of the received user data to the host computer.

1.-41. (canceled)

42. A method performed by a network node configured to operate as a source network node of a reconfiguration procedure, the method comprising:
receiving, from a candidate target network node of the reconfiguration procedure, information predicted to characterize service that the candidate target network node would provide to a wireless communication device if the candidate target network node were to be a target of the reconfiguration procedure; and
making a decision based on the received information.

43. The method of claim 42, wherein the reconfiguration procedure is a mobility procedure, a multi-connectivity procedure, a PSCell addition or change procedure, or a conditional reconfiguration procedure.

44. The method of claim 42, wherein the information is predicted to characterize a performance of service that the candidate target network node would provide to a wireless communication device if the candidate target network node were to be a target of the reconfiguration procedure, wherein the information is predicted to characterize the performance at an application layer, wherein the information is predicted to characterize the performance in terms of one or more of:
throughput;
delay;
jitter;
packet error rate;
block error rate; or
traffic pattern.

45. The method of claim 42, wherein the information is predicted to characterize a duration of time for which the candidate target network node would provide service to a wireless communication device if the candidate target network node were to be a target of the reconfiguration procedure.

46. The method of claim 42, wherein the information is predicted to characterize:
radio configuration that the candidate target network node would use to provide service to a wireless communication device if the candidate target network node were to be a target of the reconfiguration procedure; and/or
radio resources used by service that the candidate target network node would provide to a wireless communication device if the candidate target network node were to be a target of the reconfiguration procedure.

47. The method of claim 42, wherein the information is predicted to characterize energy consumption attributable to service that the candidate target network node would provide to the wireless communication device if the candidate target network node were to be a target of the reconfiguration procedure, wherein the information is predicted to characterize the energy consumption in terms of energy consumed by the candidate target network node and/or energy consumed by the wireless communication device.

48. The method of claim 42, wherein the information comprises:
for each of one or more serving cells of the candidate target network node, information predicted to characterize service that the serving cell of the candidate target network node would provide to a wireless communication device if the serving cell of the candidate target network node were to be a target of the reconfiguration procedure;
for each of one or more candidate device configurations, information predicted to characterize service that the candidate target network node would provide to a wireless communication device configured with that candidate device configuration if the candidate target network node were to be a target of the reconfiguration procedure; or
for each of one or more service types, information predicted to characterize the service that the candidate target network node would provide to a wireless communication device if the candidate target network node were to be a target of the reconfiguration procedure.

49. The method of claim 42, further comprising transmitting, to the candidate target network node, a request for the information, and wherein the information is received in response to the request, wherein the request indicates:
one or more capabilities of the wireless communication device;
results of one or more radio measurements of the wireless communication device;
a trajectory of the wireless communication device;
one or more cells for which the information is requested;
one or more service types for which the information is requested; and/or
one or more candidate device configurations for which the information is requested.

50. The method of claim 42, wherein the decision is:
a decision about whether the candidate target network node is to be a target of the reconfiguration procedure;
a decision about which of one or more candidate target network nodes is to be a target of the reconfiguration procedure;
a decision about whether the wireless communication device is to perform the reconfiguration procedure; or
a decision about how to configure one or more parameters governing mobility of, or traffic steering of, the wireless communication device.

51. A method performed by a network node configured to operate as a candidate target network node of a reconfiguration procedure, the method comprising:
transmitting, to a source network node of the reconfiguration procedure, information predicted to characterize service that the candidate target network node would provide to a wireless communication device if the candidate target network node were to be a target of the reconfiguration procedure.

52. The method of claim 51, wherein the reconfiguration procedure is a mobility procedure, a multi-connectivity procedure, a PSCell addition or change procedure, or a conditional reconfiguration procedure.

53. The method of claim 51, wherein the information is predicted to characterize a performance of service that the candidate target network node would provide to a wireless communication device if the candidate target network node were to be a target of the reconfiguration procedure, wherein the information is predicted to characterize the performance at an application layer, and wherein the information is predicted to characterize the performance in terms of one or more of:
throughput;
delay;
jitter;
packet error rate;
block error rate; or
traffic pattern.

54. The method of claim 51, wherein the information is predicted to characterize a duration of time for which the candidate target network node would provide service to a wireless communication device if the candidate target network node were to be a target of the reconfiguration procedure.

55. The method of claim 51, wherein the information is predicted to characterize:
radio configuration that the candidate target network node would use to provide service to a wireless communication device if the candidate target network node were to be a target of the reconfiguration procedure; and/or
radio resources used by service that the candidate target network node would provide to a wireless communication device if the candidate target network node were to be a target of the reconfiguration procedure.

56. The method of claim 51, wherein the information is predicted to characterize energy consumption attributable to service that the candidate target network node would provide to the wireless communication device if the candidate target network node were to be a target of the reconfiguration procedure, wherein the information is predicted to characterize the energy consumption in terms of energy consumed by the candidate target network node and/or energy consumed by the wireless communication device.

57. The method of claim 51, wherein the information comprises:
for each of one or more serving cells of the candidate target network node, information predicted to characterize service that the serving cell of the candidate target network node would provide to a wireless communication device if the serving cell of the candidate target network node were to be a target of the reconfiguration procedure;
for each of one or more candidate device configurations, information predicted to characterize service that the candidate target network node would provide to a wireless communication device configured with that candidate device configuration if the candidate target network node were to be a target of the reconfiguration procedure; or
for each of one or more service types, information predicted to characterize the service that the candidate target network node would provide to a wireless communication device if the candidate target network node were to be a target of the reconfiguration procedure.

58. The method of claim 51, further comprising predicting the information as characterizing service that the candidate target network node would provide to a wireless communication device if the candidate target network node were to be a target of the reconfiguration procedure, and wherein the information transmitted is the predicted information.

59. The method of claim 58, further comprising:
training a machine learning model to predict the information; and
predicting the information using the machine learning model.

60. A network node configured to operate as a source network node of a reconfiguration procedure, the network node comprising:
communication circuitry; and
processing circuitry configured to:
receive, from a candidate target network node of the reconfiguration procedure, via the communication circuitry, information predicted to characterize service that the candidate target network node would provide to a wireless communication device if the candidate target network node were to be a target of the reconfiguration procedure; and
make a decision based on the received information.

61. A network node configured to operate as a candidate target network node of a reconfiguration procedure, the network node comprising:
communication circuitry; and
processing circuitry configured to transmit, to a source network node of the reconfiguration procedure, via the communication circuitry, information predicted to characterize service that the candidate target network node would provide to a wireless communication device if the candidate target network node were to be a target of the reconfiguration procedure.
